(19) United States
(12) Patent Application Publication
(10) Pub. No.: US 2026/0146217 A1
(43) Pub. Date: May 28, 2026

(54) LAUNDRY CARE ADDITIVE PARTICLES

(71) Applicant: The Procter & Gamble Company, Cincinnati, OH (US)

(72) Inventors: Kristin Rhedrick WILLIAMS, West Chester, OH (US); Johan SMETS, Lubbeek (BE); Mattia COLLU, SAINT-GILLES (BE); Peter DE NIES, ANTWERPEN (BE); Laura ORLANDINI, LE MONT-SUR-LAUSANNE (CH)

(21) Appl. No.: 19/389,106

(22) Filed: Nov. 14, 2025

Related U.S. Application Data
(60) Provisional application No. 63/723,851, filed on Nov. 22, 2024.

(51) Int. Cl. C11D 17/00

(52) U.S. Cl. CPC C11D 17/0039; C11D 17/0013; C11D 2111/12

(57) ABSTRACT

A composition including a plurality of particles and a process of making such particles, wherein the particles include: a water-soluble carrier, and a plurality of capsules dispersed in the water-soluble carrier, wherein the capsules comprise a core and a shell surrounding the core and the core includes a benefit agent; wherein the capsules are bio-based.

### FIELD OF THE INVENTION

Laundry care particles providing improved scent delivery and methods of making the same are described herein.

### BACKGROUND OF THE INVENTION

Laundry care particles are formulated with perfumed core/shell capsules. Typically, the cores of such capsules include perfume, and the shell often comprises a polymeric material such as an aminoplast, a polyurea, or a polyacrylate, or a naturally derived material such as gelatine, lysine or chitosan. These capsules are useful in delivering the benefit agent to a target surface, such as a fabric. Then, at various touchpoints, the capsules will release the perfume after manipulation.

While naturally derived capsules are highly desired by consumers, they present problems in manufacturing. Specifically, naturally derived capsules are difficult to include in particulate laundry products due to their lack of durability in some manufacturing processes.

With the above limitations in mind, there is a continuing unaddressed need for particulate laundry products having appropriately durable capsules.

### SUMMARY OF THE INVENTION

Compositions and processes of the present disclosure can reduce the amount of leakage from capsules that are comprised by laundry additive particles. A process in accordance with the present disclosure comprises the steps of: (i) mixing and heating a precursor material comprising a water-soluble carrier, wherein the precursor material is heated to a first temperature, and wherein the precursor material is maintained at the first temperature for a first time period; (ii) mixing bio-based capsules with the precursor material such that the bio-based capsules are at or near the first temperature for a second time period, wherein the second time period is less than the first time period, and wherein the second time period is less than about 20 minutes, preferably less than about 10 minutes, more preferably less than about 7 minutes or even more preferably less than about 5 minutes, wherein the mixture of the bio-based capsules and the precursor material form a resultant mixture; and (iv) providing the resultant mixture to a distributor.

Another suitable process comprises the steps of: (i) mixing and heating a precursor material comprising a water-soluble carrier, wherein the precursor material is heated to a first temperature, and wherein the precursor material is at the first temperature; (ii) adding bio-based capsules to the precursor material; (iii) providing the precursor material and the bio-based capsules to an intermediate mixer thereby forming a resultant mixture; (iv) providing the resultant mixture to a distributor, and wherein the bio-based capsules comprise a core and a shell surrounding said core and said core comprises one or more benefit agents, wherein said shell comprises from about 90% to 100%, optionally from about 95% to 100%, optionally from about 99% to 100% by weight of the shell of a polymeric material that is the reaction product of chitosan derived from an aqueous phase and a cross-linking agent, wherein the cross-linking agent comprises an isocyanate component, comprising a mixture of two or more di- and/or poly-isocyanates, derived from an oil phase, the di- and/or poly-isocyanates each comprising an aromatic moiety; and wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.

### BRIEF DESCRIPTION OF THE DRAWINGS

FIG. 1A is a schematic of a pastillation apparatus for making particles.

FIG. 1B is a schematic of a precursor material of the present disclosure flowing through a feedpipe in the apparatus of FIG. 1A.

FIG. 1C is a schematic of the distributor in the apparatus of FIG. 1A.

FIG. 2 is a schematic showing a precursor material of the present disclosure flowing through another feedpipe of the present disclosure.

### DETAILED DESCRIPTION OF THE INVENTION

The present disclosure relates to laundry care additive particles that include a water-soluble carrier, a plurality of perfume containing capsules dispersed in the carrier and optionally, free perfume(s) and dye(s) disposed within the water-soluble carrier. The laundry care additive particles of the present disclosure can provide long lasting perfume delivery with the utilization of naturally derived and/or biodegradable capsules.

The laundry care additive particles can be practical for providing benefits to laundry through the wash. That is, the particles can be employed by the user by dispensing the particles into the washing machine prior to starting the washing machine cycle, particularly the wash sub-cycle. Through the wash compositions, such as those described herein, differ from through the rinse compositions.

Through the rinse compositions are designed to be dispensed during the rinse sub-cycle of the washing machine. In modern washing machines, the rinse sub-cycle is initiated automatically after the wash sub-cycle is completed, without any further input from the consumer. Compositions that are to be dispensed during the rinse sub-cycle are commonly dosed to a separate dosing chamber that is part of the washing machine that dispenses the through the rinse composition during the rinse sub-cycle, for example a dispensing drawer or from that agitator in the tub.

As noted, the laundry care additive particles of the present disclosure may comprise naturally derived and/or biodegradable capsules, hereafter, “bio-based” capsules. However, bio-based capsules can be very process sensitive. Specifically, many bio-based capsules degrade and lose their ability to deliver perfume when utilized with some particular processes.

The particles of the composition can be made by a process comprising multiple steps. The particles can be formed by tableting or melt processing. Preferably melt processing is utilized as better dissolution properties can be obtained.

Before diving into the preferred processes, it is worth discussing the constituents of the laundry additive particles of the present disclosure. The laundry additive particles of the present disclosure comprise a water-soluble carrier material (which can be a singular or a mixture of materials), a plurality of bio-based capsules, preferably a dye, and preferably free perfume. Each of these constituents is discussed in additional detail herein.

In a melt processing process, the carrier material is typically combined with capsules along with the optional dye and free perfume. In some processes, the capsules are mixed with the carrier material and then the resultant mixture (carrier material plus perfume filled capsules plus optional ingredients) is stored. For example, a resultant mixture can be prepared comprising about 25% to about 99% by weight water-soluble carrier and about 0.1% to about 20% by weight capsules. To ensure that the resultant mixture is flowable, the resultant mixture may be stored at an elevated temperature. Generally, this elevated temperature is above the melting temperature of the carrier material.

In commercial processing, the amount of resultant mixture stored can be quite large. This ensures that downstream processing can continue with very low frequency of interruption due to the running out of the resultant mixture. Unfortunately, the large amount of resultant mixture stored means that the perfume filled capsules are exposed to a high level of heat for a long period of time, e.g. greater than 2 hours.

The inventors have surprisingly found that long exposure to heat of certain types of perfume filled capsules causes degradation of the capsule and premature leakage of perfume from the capsule.

Specifically, bio-based capsules can lose their liquid perfume without manipulation when exposed to particular processes. The general structure of the capsules, whether naturally derived and/or biodegradable, is shell and core. The capsules comprise a shell which forms an open core. Upon formation of the shell, perfumes, preferably liquid, and/or benefit agents are trapped and ultimately encapsulated within the core and can be released when the shells are ruptured, via a release trigger, e.g., physical touch, exposure to humidity or UV-visible light or other manipulation.

It is believed that when these bio-based capsules are exposed to heat for extended periods of time, water surrounding their shell depletes or is reduced. This reduction of water drives perfume from the core. If this occurs on a massive scale, most capsules, when exposed to a release trigger or otherwise manipulated, will not release any perfume. Such loss of perfume detrimentally impacts the consumer perception of the performance of the particles.

As noted, the impacted capsules are generally in the class of bio-based capsules. For environmental reasons, it may be desirable to use capsules that have a shell made from naturally derived and/or biodegradable materials, such as biopolymers.

The inventors have discovered several ways to overcome the degradation to bio-based capsules. For example, there are processes which can be utilized which minimize heat and/or time experienced by the capsules during processing. Such processes are described herein in additional detail.

Also, in conjunction with or independently of the process changes, there are particular types of bio-based capsules which are more resistant to extended exposure to heat. These capsules are also described in additional detail herein. Such bio-based capsules are referred to herein as “HR bio-based capsules.”

The terms “substantially free of” or “substantially free from” may be used herein. This means that the indicated material is at the very minimum not deliberately added to the composition to form part of it, or, optionally, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure.

As described herein, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Processes for Making Additive Particles

### Batch Processing

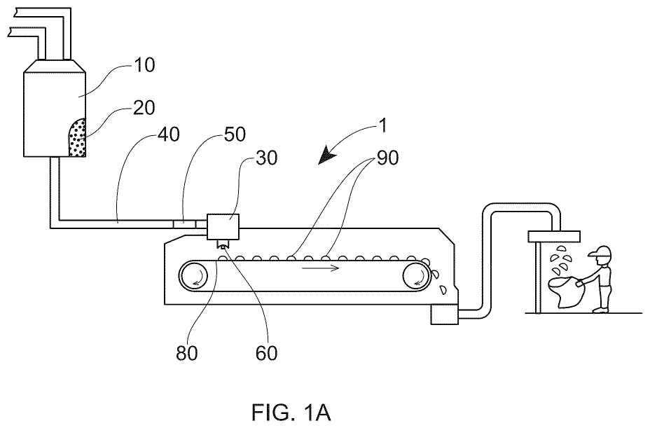

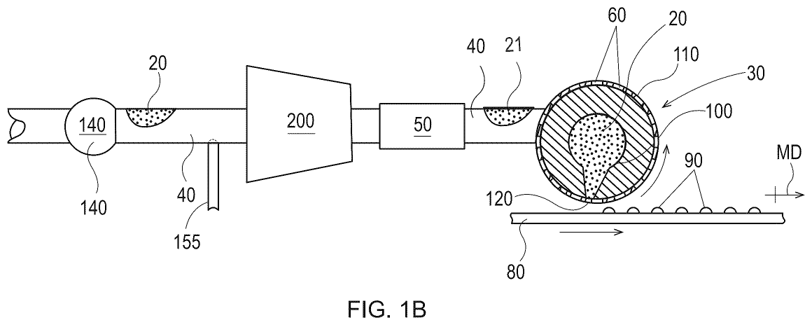

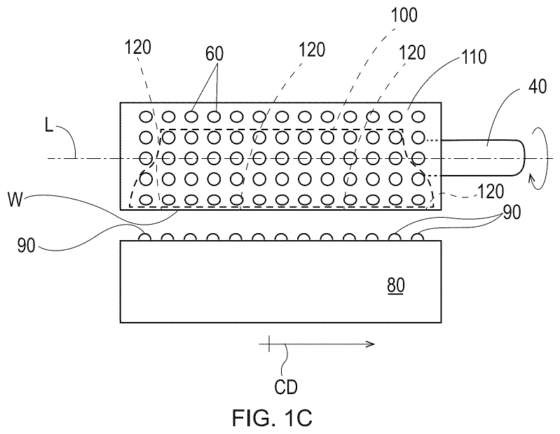

Referring to FIG. 1A, the particles of the or the present disclosure can be formed by using a particle making apparatus 1. Raw material(s) can be provided to a batch mixer 10. Precursor material 20 can leave the batch mixer 10 via feedpipe 40. Feedpipe 40 may provide the precursor material 20 to an intermediate mixer 50 and then to a distributor 30. The distributor 30 may then deposit the precursor material 20 on a conveyor 80 to form particles 90.

The batch mixer 10 can have sufficient capacity to retain the volume of raw materials provided thereto for a sufficient residence time to permit the desired level of mixing and or reaction of the raw materials and/or to reduce downtime of downstream processes from the mixer. The batch mixer 10 can be a dynamic mixer. A dynamic mixer is a mixer to which energy is applied to mix the contents in the mixer.

The precursor material 20 can leave the batch mixer 10, preferably in molten form. For example, when the carrier is a water-soluble polymer, the water-soluble polymer can be heated to a temperature that is above the water-soluble polymer onset of melt and below the flash point or boiling point of the perfume within the capsule. Precursor material 20 may comprise optional ingredients, e.g., dyes and free perfumes. However, preferably, the bio-based capsules are not provided as part of the precursor material 20—unless the bio-based capsules are HR bio-based capsules as described herein. Additionally, the free perfume may similarly not be provided as part of the precursor material 20. It is believed that the addition of free perfume to the precursor material 20 can increase the amount of evaporation of the free perfume. As such, the addition of free perfume to the precursor material 20, preferably occurs downstream of the batch mixer 10. For example, the addition of free perfume may occur simultaneously with the addition of the bio-based capsules. As another example, the addition of free perfume may occur prior to or after the addition of the bio-based capsules but nonetheless downstream of the batch mixer 10. Optionally, the precursor material can be provided to the feed pipe 40 from some other upstream mixing process, for example in-line mixing, in-line static mixing, and the like.

As noted, the intermediate mixer 50 may be disposed between the batch mixer 10 and the distributor 30. The intermediate mixer 50 can be in-line with the feed pipe 40. Any suitable mixer may be utilized.

Conventional particle processing would see the bio-based capsules provided to the batch mixer 10. However, as noted, bio-based capsules may not be able to withstand the extended exposure to heat within the batch mixer 10 or the elevated temperature storage of the contents within the batch mixer 10 and/or storage tank. Accordingly, the inventors have discovered that injection of bio-based capsules in such processes may be beneficially provided to the feed pipe 40 upstream of the intermediate mixer 50 and downstream of the batch mixer 10. This late addition of the capsules to the precursor material in the batch process (referred to as “late addition batch” in Table 6 and elsewhere herein) can greatly reduce the loss of benefit agent from the core of the capsules. The addition of the bio-based capsules upstream of the intermediate mixer 50 can ensure a homogeneous distribution of capsules throughout the precursor material 20. Additionally, where a mill 200 is present, the bio-based capsules may be provided to the feed pipe 40 upstream of the mill 200 and downstream of the batch mixer 10. In such configurations, the bio-based capsules may benefit from being mixed in the mill 200 with additional mixing in the intermediate mixer 50. Regardless of whether the bio-based capsules are provided upstream of the mill 200 or upstream of the intermediate mixer 50, the purpose of either is to ensure that the bio-based capsules are thoroughly mixed within the precursor material 20 and preferably mixed such that the bio-based capsules are homogeneously dispersed throughout the precursor material 20.

It is believed that by providing the bio-based capsules downstream of the batch mixer 10 and/or elevated temperature storage thereof, the bio-based capsules are subjected to heat for a much shorter period of time than that of conventional batch processing. Recall, when the carrier is a water-soluble polymer, the water-soluble polymer can be heated to a temperature that is above the water-soluble polymer onset of melt and below the flash point or boiling point of the perfume within the capsule. Due to the nature of batch processing, the precursor material may be maintained at an elevated temperature for an extended period of time. For example, in conventional processing where capsules are typically added to the batch mixer 10, the capsules may experience elevated temperatures, e.g., 60 degrees C. to about 90 degrees C., for a period of several hours, e.g., greater than 2 hours. However, with the inventive process changes described herein, the bio-based capsules may experience elevated temperatures for a much shorter period of time. For example, the bio-based capsules processed in accordance with the process of the present disclosure experience elevated temperatures for a matter of minutes, e.g., less than about 20 minutes, preferably less than about 10 minutes, more preferably less than about 7 minutes, or even more preferably less than about 5 minutes. Further the bio-based capsules may experience elevated temperatures for from between about 0.5 minutes to about 20 minutes, preferably from about 0.5 minutes to about 10 minutes, even more preferably from about 0.5 minutes to about 7 minutes, or most preferably from about 0.5 minutes to about 5 minutes.

Referring now to FIGS. 1A-1B, the flow of the precursor material 20 through the feed pipe 40 can be provided by gravity driven flow from a batch mixer 10 to the distributor 30. To provide for more controllable manufacturing, the apparatus 1 can be provided with a feed pump 140, as shown in FIG. 1B. The feed pump 140 can be in line with the feed pipe 40, with in line meaning in the line of flow of the precursor material 20. The feed pump 140 can between the batch mixer 10 and the distributor 30. If a stator 100 is employed, the feed pump 140 can be between the batch mixer 10 and the stator 100. The feed pump 140 can be upstream of the stator 100. The mill 200 can be positioned in line between the feed pump 140 and the distributor 30 or stator 100, if employed in the apparatus 1.

The flow rate of the precursor material 20 can be about 3 L/min. Similarly, even after the addition of the bio-based capsules, the flow rate of a resultant mixture 21 (precursor material 20 plus bio-based capsules) can be about 3 L/min. The precursor material 20 can be a molten material comprising any of the compositions described herein for the precursor material 20 or particles 90. Suitable examples of precursor material 20 and its constituents is provided herein.

After the addition of the bio-based capsules, the bio-based capsules and the precursor material 20 are mixed via the intermediate mixer 50 and/or mill 200. The resultant mixture 21 is then provided to the distributor 30.

The distributor 30 can be provided with a plurality of apertures 60 through which the resultant mixture 21 is passed. The distributor 30 can be a cylinder 110 rotationally mounted about a stator 100 with the stator being in fluid communication with the feed pipe 40 and the cylinder 110 can have a periphery 120 and there can be a plurality of apertures 60 in the periphery 120, as shown in FIG. 1B. So, the apparatus 1 can comprise a stator 100 in fluid communication with the feed pipe 40. The feed pipe 40 can feed the resultant mixture 21 to the stator 100 after the precursor material 20 has passed through the mill 200.

The apparatus 1 can comprise a cylinder 110 rotationally mounted about the stator 100. The stator 100 is fed resultant mixture 21 through one or both ends 130 of the cylinder 110. The cylinder 110 can have a longitudinal axis L passing through the cylinder 110 about which the cylinder 110 rotates. The cylinder 110 has a periphery 120. There can be a plurality of apertures 60 in the periphery 120 of the cylinder 110.

Referring now to FIG. 1C, as the cylinder 110 is driven to rotate about its longitudinal axis L, the apertures 60 can be intermittently in fluid communication with the stator 100 as the cylinder 110 rotates about the stator 100. The cylinder 110 can be considered to have a machine direction MD in a direction of movement of the periphery 120 across the stator 100 and a cross machine direction on the periphery 120 orthogonal to the machine direction MD. The stator 100 can similarly be considered to have a cross machine direction CD parallel to the longitudinal axis L. The cross machine direction of the stator 100 can be aligned with the cross machine direction of the cylinder 110. The stator 100 can have a plurality of distribution ports 120 arranged in a cross machine direction CD of the stator 100. The distribution ports 120 are portions or zones of the stator 100 supplied with resultant mixture 21. As shown, the apparatus 1 can have an operating width W and the cylinder 110 can rotate about longitudinal axis L.

The stator 100 distributes the resultant mixture 21 across the operating width of the cylinder 110. As the cylinder 110 rotates about its longitudinal axis, resultant mixture 21 is fed through the apertures 60 as the apertures 60 pass by the stator 100. A discrete mass of resultant mixture 21 is fed through each aperture 60 as each aperture 60 encounters the stator 100. The mass of resultant mixture 21 fed through each aperture 60 as each aperture 60 passes by the stator 100 can be controlled by controlling one or both of the pressure of the resultant mixture 21 within the stator 100 and the rotational velocity of the cylinder 110.

Drops of the resultant mixture 21 are deposited on the conveyor 80 across the operating width of the cylinder 110. The conveyor 80 can be moveable in translation relative to the longitudinal axis of the cylinder 110. The velocity of the conveyor 80 can be set relative to the tangential velocity of the cylinder 110 to control the shape that the resultant mixture 21 has once it is deposited on the conveyor 80. The velocity of the conveyor 80 can be the about the same as the tangential velocity of the cylinder 110. However, in one example, the velocity of the conveyor may be faster than the tangential velocity of the cylinder 110 so that elongated particles may be produced. In still another example, the velocity of the conveyor may be slower than the tangential velocity of the cylinder 110 which can yield more bulky particles, more spherical in nature. In such configuration, additional cooling of the conveyor may be required.

After passing through the apertures 60, the resultant mixture 21 can be deposited on a moving conveyor 80 that is provided beneath the distributor 30. The resultant mixture 21 can be deposited on the moving conveyor 80 when the conveyor 80 is in motion. The conveyor 80 can be moveable in translation relative to the distributor 30. The conveyor 80 can be a continuously moving conveyor 80 or an intermittently moving conveyor 80. A continuously moving conveyor 80 may provide for higher processing speeds while an intermittently moving conveyor 80 can provide for improved control of the shape of the particles 90 that are produced.

The resultant mixture 21 can be cooled on the moving conveyor 80 to form a plurality of solid particles 90. The conveyor 80 may comprise a plurality of mold depressions into which the resultant mixture 21 is provided. The cooling can be provided by ambient cooling. Optionally the cooling can be provided by spraying the under-side of the conveyor 80 with ambient temperature water or chilled water. Once the particles 90 are sufficiently coherent, the particles 90 can be transferred from the conveyor 80 to processing equipment downstream of the conveyor 80 for further processing and or packaging.

Optionally, the particles 90 can be formed by passing resultant mixture 21 through one or more apertures 60 of a distributor and depositing the mixture on a moving conveyor 80 beneath the one or more apertures 60. The resultant mixture 21 may be solidified to form the particles 90. The resultant mixture 21 may be deposited on the moving conveyor 80 as an extrudate and the extrudate can be cut to form the particles 90. Or the resultant mixture 21 can be passed through the one or more apertures 60 to form droplets on the moving conveyor 80 and the droplets can be solidified to form the particles 90.

### Continuous Processing

Similar to the solutions presented for the foregoing process, the inventors have surprisingly found that in some instances, a continuous process can be utilized to limit the time of exposure to elevated temperatures by bio-based capsules.

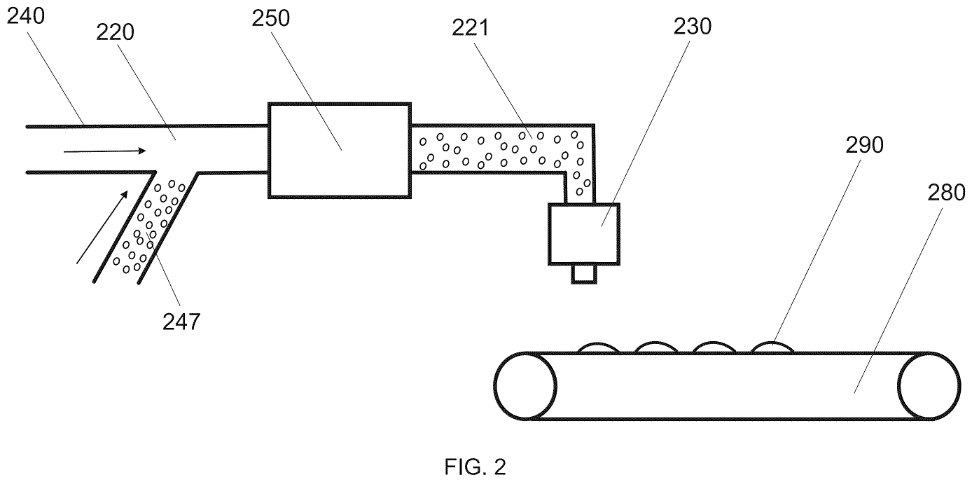

Referring now to FIG. 2, for the continuous processes of the present disclosure, precursor material 220 is provided in feed pipe 240 and provided to a distributor 230. The distributor 230 may be configured as described above regarding distributor 30. The precursor material 220 may be provided by a continuous mixer. Continuous mixers are well known in the art, and any suitable continuous mixer may be utilized.

The major difference between the continuous process and the batch process of the present disclosure, is that the precursor material 20 (FIGS. 1A-1C) is made in batches as opposed to the precursor material 220 is made continuously. Much like the precursor material 20, the precursor material 220 is heated to facilitate flowability of the precursor material 220 through the feedpipe 240. The precursor material 220 can be heated to between about 60 to about 90 degrees C.

To minimize the duration of time experienced by the bio-based capsules, the capsules 247 may be added upstream of an intermediate mixer 250 which is positioned between a source of the precursor material 220 and the distributor 230. It is worth noting that the capsules 247 may be added to the precursor material 220 in the continuous mixer; however, care should be taken to ensure that the capsules do not experience an extended duration at elevated temperatures as described previously.

The precursor material 220 may comprise a carrier material along with other constituents as described herein, similar to the precursor material 20. For example, the precursor material may comprise free perfume, and one or more dyes. Alternatively, the addition of free perfume to the precursor material 220 may be as described herein regarding the batch process.

Downstream of the intermediate mixer 250, a resultant mixture 221 comprising the carrier material, other constituents and the capsules 247 can be provided to the distributor 230. Once provided to the distributor 230, the resultant mixture 221 can undergo the same or at least a similar process to that described previously regarding the batch process and the distributor 30.

Bio-Based Capsules for Use with the Particles

The bio-based capsules of the present disclosure comprise a shell surrounding a core. (As used herein, “shell” and “wall” are used interchangeably with regard to the capsules, unless indicated otherwise.) The shell comprises a bio-based material which can, for example, be the reaction product of chitosan and a cross-linking agent. The core comprises a benefit agent and/or partitioning modifier, each of which are described in additional detail herein.

The capsules may be characterized by a volume-weighted median capsule size from about 1 to about 150 microns, preferably from about 10 to about 100 microns, preferably from about 15 to about 75 microns, or more preferably from about 20 to about 50 microns. For certain compositions, it may be preferred that the population of delivery particles is characterized by a volume-weighted median capsule size from about 1 to about 50 microns, preferably from about 5 to about 20 microns, more preferably from about 10 to about 15 microns. Different particle sizes are obtainable by controlling droplet size during emulsification.

The core-shell encapsulate can have a ratio of core to shell of at least 75:25, or 85:15, or 90:10, or even up to 99:1, or even at least 99.5:0.5, on the basis of weight. The shell can comprise 1 to 25 percent by weight of the core-shell encapsulate. The shell may be present at a level of from about 1% to about 25%, preferably from about 1% to about 20%, preferably from about 1% to 15%, more preferably from about 5% to about 15%, even more preferably from about 10% to about 15%, even more preferably from about 10% to about 12%, by weight of the delivery particle. The shell may be present at a level of least 1%, preferably at least 3%, more preferably at least 5% by weight of the delivery particle. The shell may be present at a level of up to about 25%, preferably up to about 20%, preferably up to about 15%, more preferably up to about 12%, by weight of the delivery particle.

The capsules may be cationic in nature, preferably cationic at a pH of 4.5. The capsules may be characterized by a zeta potential of at least 15 millivolts (mV) at a pH of 4.5. The capsules can be fashioned to have a zeta potential of at least 15 millivolts (mV) at a pH of 4.5, or even at least 40 m V at a pH of 4.5, or even at least 60 mV at a pH of 4.5. Capsules prepared with chitosan typically exhibit positive zeta potentials. Such capsules have improved deposition efficiency on fabrics. At higher pH, the particles may be able to be made nonionic or anionic.

The chitosan may be characterized by a weight average molecular weight of from about 100 kDa to about 600 kDa. Preferably, the chitosan is characterized by a weight average molecular weight (Mw) of from about 100 kDa to about 500 kDa, preferably from about 100 kDa to about 400 kDa, more preferably from about 100 kDa to about 300 kDa, even more preferably from about 100 kDa to about 200 kDa. The method used to determine the chitosan's molecular weight and related parameters is provided in the Test Methods section below and uses gel permeation chromatograph with multi-angle light scatter and refractive index detection (GPC-MALS/RI) techniques. Selecting chitosan having the preferred weight average molecular weight can result in capsules having suitable shell formation and/or desirable processibility. For clarity the chitosan weight average molecular weight is measured prior to treatment, such as with acid and/or redox initiator as herein described.

In addition to weight average molecular weight, preferred chitosan may be characterized by other parameters as well. For example, the chitosan may be characterized by a Polydispersity Index of from about 1.2 to about 4, more preferably from about 1.4 to about 3.8, even more preferably from about 2.2 to about 2.6. The Polydispersity Index is calculated as the ratio of weight average molecular weight to number average molecular weight (Mw/Mn).

Additionally or alternatively, the chitosan may be characterized a value defined as the difference between Z-average molecular weight and the molecular weight of the peak maxima (e.g., Mz−Mp), where the difference is from about 60 to about 3500 kDa, which can be used to describe the length of “the tail” of the molecular weight distribution. For raw (non-acid-treated) chitosan, it may be preferred that the value of Mz−Mp is from about 60 to about 600 kDa, preferably from about 140 to about 300 kDa. For acid-treated chitosan, it may be preferred that the value of Mz−Mp is from about 600 to about 3500 kDa, more preferably from about 1800 to about 3000 kDa.

The chitosan may be characterized by a degree of deacetylation of at least 50%, preferably from about 50% to about 99%, more preferably from about 75% to about 90%, even more preferably from about 80% to about 85%. The degree of deacetylation can affect the solubility of the chitosan, which in turn can affect its reactivity or behavior in the process of forming the particle shells. For example, a degree of deacetylation that is too low (e.g., below 50%) results in chitosan that is relatively insoluble and relatively unreactive. A degree of deacetylation that is relatively high can result in chitosan that is very soluble, resulting in relatively little of it traveling to the oil/water interface during shell formation.

The chitosan may be characterized by at least one, preferably at least two, more preferably all three, of the following: (a) a Polydispersity Index (Mw/Mn) of from about 2.2 to about 2.6; and/or (b) a value defined by (Mz−Mp) of from about 60 to about 3500; and/or (c) a degree of deacetylation of at least 50%, preferably from about 50% to about 99%, more preferably from about 75% to about 90%, even more preferably from about 80% to about 85%.

The chitosan may preferably be acid-treated chitosan. For example, chitosan (which, prior to acid treatment, may be referred to as raw chitosan or parent chitosan) may preferably be treated at a pH of 6.5 or less with an acid for at least one hour, preferably from about one hour to about three hours, or for a period of time required to obtain a chitosan solution viscosity of not more than about 1500 cps of the acid-treated chitosan, or even not more than 500 cps, at a temperature of from about 25° C. to about 99° C., preferably from about 75° C. to about 95° C. The acid may be selected from a strong acid (such as hydrochloric acid), an organic acid (such as formic acid or acetic acid), or a mixture thereof. The chitosan may preferably be acid-treated at a pH of from 2 to 6.5, preferably 3 to 6, or even from a pH of from 4 to 6. Acid treatment of chitosan is described in WO2024/118694, filed Dec. 1, 2022, incorporated herein by reference.

Optionally, prior to shell formation, the chitosan used to make the particle shells can be treated with a redox initiator optionally persulfate such as described in WO2024/118696 filed Dec. 1, 2022, incorporated herein by reference. The redox initiator is selected from any of persulfate or a peroxide. Optionally, the redox initiator is selected from the group of ammonium persulfate, sodium persulfate, potassium persulfate, cesium persulfate, benzoyl peroxide, hydrogen peroxide, and mixtures thereof.

Typically, when chitosan is dissolved in water, for example during the process of making capsules, the resulting mixture tends to be quite viscous. This can result in flowability and processing challenges, and/or inhibit the adequate formation of capsules shells. It has been described in WO2024/118694 that acid treatment can result in a decrease of the mixture's viscosity and an improved shell structure. Additionally, it is believed that acid treating the chitosan can beneficially affect the molecular weight of the chitosan, thereby leading to improved shell formation and/or delivery performance.

The chitosan may comprise anionically modified chitosan, cationically modified chitosan, or a combination thereof. Modifying the chitosan in an anionic and/or cationic fashion can change the character of the shell of the delivery particle, for example, by changing the surface charge and/or zeta potential, which can affect the deposition efficiency and/or formulation compatibility of the particles.

Where the benefit agent is not itself sufficient to serve as the oil phase or solvent, particularly during the process of forming the shell of the capsules for the wall forming materials, the oil phase can comprise a suitable carrier and/or solvent. In this sense, the oil is optional, as the benefit agent itself can at times be the oil. These carriers or solvents are generally an oil, preferably have a boiling point greater than about 80° C. and low volatility and are non-flammable. Though not limited thereto, they preferably comprise one or more esters, preferably with chain lengths of up to 18 carbon atoms or even up to 42 carbon atoms and/or triglycerides such as the esters of C6 to C12 fatty acids and glycerol.

The capsules described herein may be provided as a slurry, preferably an aqueous slurry. The slurry can include one or more processing aids, which may include water, aggregate inhibiting materials such as divalent salts, or particle suspending polymers such as xanthan gum, guar gum, cellulose (preferably microfibrillated cellulose) and/or carboxy methyl cellulose. When the delivery particles are characterized by a cationic nature (for example, when the shell is derived, at least in part, from chitosan), a non-anionic structurant, preferably a nonionic structurant, may be preferred, for example, to avoid detrimental charge interactions that may lead to undesirable aggregation.

The slurry can include one or more carriers selected from the group consisting of polar solvents, including but not limited to, water, ethylene glycol, propylene glycol, polyethylene glycol, glycerol; nonpolar solvents, including but not limited to, mineral oil, perfume raw materials, silicone oils, hydrocarbon paraffin oils; and mixtures thereof. Aqueous slurries may be preferred. The slurry may comprise non-encapsulated (or “free”) perfume raw materials that are different in identity and/or amount from those that are encapsulated in the cores of the delivery particles.

The slurry may include a deposition aid that may comprise a polymer selected from the group comprising: polysaccharides, such as chitosan, cationically modified starch and/or cationically modified guar; polysiloxanes; poly diallyl dimethyl ammonium halides; copolymers of poly diallyl dimethyl ammonium chloride and polyvinyl pyrrolidone; a composition comprising polyethylene glycol and polyvinyl pyrrolidone; acrylamides; imidazoles; imidazolinium halides; polyvinyl amine; copolymers of poly vinyl amine and N-vinyl formamide; polyvinyl formamide, polyvinyl alcohol; polyvinyl alcohol crosslinked with boric acid; polyacrylic acid; polyglycerol ether silicone cross-polymers; polyacrylic acids, polyacrylates, copolymers of polyvinylamine and polvyinylalcohol oligomers of amines, in one aspect a diethylenetriamine, ethylene diamine, bis(3-aminopropyl)piperazine, N,N-Bis-(3-aminopropyl)methylamine, tris(2-aminoethyl)amine and mixtures thereof; polyethyleneimine, a derivatized polyethyleneimine, in one aspect an ethoxylated polyethyleneimine; a polymeric compound comprising, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; pre-formed coacervates of anionic surfactants combined with cationic polymers; polyamines and mixtures thereof.

At least a portion of the capsules may be contained in an agglomerate and then combined with a second portion of capsules and at least one adjunct material. Said agglomerate may comprise materials selected from the group consisting of silicas, citric acid, sodium carbonate, sodium sulfate, sodium chloride, and binders such as sodium silicates, modified celluloses, polyethylene glycols, polyacrylates, polyacrylic acids, zeolites and mixtures thereof.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

Regardless of the capsules utilized, the capsules may be present in the particles of the composition in an amount that is from about 0.1% to about 20%, or from about 0.2% to about 10%, or from about 0.2% to about 5%, or from about 0.2% to about 3%, by weight of the composition. The composition may comprise a sufficient amount of capsules to provide from about 0.1% to about 20%, or from about 0.2% to about 10%, or from about 0.2% to about 5%, by weight of the composition, of perfume raw materials to the composition. When discussing herein the amount or weight percentage of the capsules, it is meant the sum of the shell material and the core material.

The shell of the bio-based capsules may degrade at least 50% after 20 days (or less) when tested according to test method OECD 301B. The shell may degrade at least 60% of its mass after 60 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

Bio-Based Capsules for Use with the Processes Described Herein.

The bio-based capsules described in this section are suitable for use with the late addition batch process as well as the continuous process within the time frames discussed herein in order to minimize the loss of benefit agents from their core.

As mentioned above, the shell can be a polymeric material that is the reaction product of the chitosan and a cross-linking agent. Preferably, the cross-linking agent comprises a polyisocyanate. Thus, the shell of the delivery particles may comprise a polyurea resin, wherein the polyurea resin comprises the reaction product of a polyisocyanate and a chitosan.

The polyisocyanate material useful in the present disclosure is to be understood for purposes hereof as isocyanate monomer, isocyanate oligomer, isocyanate prepolymer, or dimer or trimer of an aliphatic or aromatic isocyanate. By “polyisocyanate,” it is intended to mean a material or compound that includes two or more isocyanate moieties. All such monomers, prepolymers, oligomers, or dimers or trimers of aliphatic or aromatic isocyanates are intended encompassed by the term “polyisocyanate” herein. The polyisocyanates useful in the present disclosure comprise isocyanate monomers, oligomers or prepolymers, or dimers or trimers thereof, having at least two isocyanate groups. Preferred cross-linking can be achieved with polyisocyanates having at least three functional groups.

Aromatic polyisocyanates may be preferred; however, aliphatic polyisocyanates and blends thereof may be useful. Aliphatic polyisocyanate is understood as a polyisocyanate which does not comprise any aromatic moiety. The cross-linking agent may comprise a mixture of an aromatic polyisocyanate and an aliphatic polyisocyanate.

The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or naphthalene-1,5-diisocyanate, and phenylene diisocyanate.

Aliphatic polyisocyanates may include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100), or trimethylol propane-adduct of xylylene diisocyanate (commercially available from Mitsui Chemicals under the tradename Takenate® D-110N),

Derivatives of polyisocyanates may include oligomers or polymers of isocyanate monomers. As a non-limiting example, the polyisocyanate may preferably comprise an oligomer or polymer of diphenylmethane diisocyanate (MDI), such as Mondur® MR-Light.

The polyisocyanate may preferably be selected from the group consisting of: a polyisocyanurate of toluene diisocyanate; a trimethylol propane adduct of toluene diisocyanate; a trimethylol propane adduct of xylylene diisocyanate; 2,2′-methylenediphenyl diisocyanate; 4,4′-methylenediphenyl diisocyanate; 2,4′-methylenediphenyl diisocyanate; [diisocyanato(phenyl)methyl]benzene; toluene diisocyanate; tetramethylxylidene diisocyanate; naphthalene-1,5-diisocyanate; 1,4-phenylene diisocyanate; 1,3-diisocyanatobenzene; derivatives thereof (such as pre-polymers, oligomers, and/or polymers thereof); and combinations thereof.

The capsule shell may also be reinforced using additional co-crosslinkers such as multifunctional amines and/or polyamines, such as diethylene triamine (DETA), polyethylene imine, polyvinyl amine, or mixtures thereof. Acrylates may also be used as additional co-crosslinkers, for example to reinforce the shell.

The polymeric material may be formed in a reaction, where the weight ratio of the chitosan present in the reaction to the cross-linker present in the reaction is from about 1:10 to about 1:0.1. It is believed that selecting desirable ratios of the biopolymer to the cross-linking agent can provide desired mechanical properties of the capsules, as well as improved biodegradability. It may be preferred that at least 21 wt % of the shell is comprised of moieties derived from chitosan, preferably from acid-treated chitosan. Chitosan as a percentage by weight of the shell may be from about 21% up to about 95% of the shell. The ratio of chitosan in the water phase as compared to the cross-linker, preferably an isocyanate, in the oil phase may be, based on weight, from 21:79 to 90:10, or even from 1:2 to 10:1, or even from 1:1 to 7:1. The polymeric material may be formed in a reaction, where the weight ratio of the chitosan or a derivative thereof (which can include acid-treated chitosan) present in the reaction to the cross-linker present in the reaction is from about 1:10 to about 10:1, preferably from about 1:5 to about 5:1, preferably from about 1:4 to about 5:1, more preferably from about 1:1 to about 5:1, more preferably from about 3:1 to about 5:1. The shell may comprise chitosan at a level of 21 wt % or even greater, preferably from about 21 wt % to about 90 wt %, or even from 21 wt % to 85 wt %, or even 21 wt % to 75 wt %, or 21 wt % to 55 wt % of the total shell being chitosan. The chitosan may preferably be acid-treated chitosan.

The capsules may be made according to a process that comprises the following steps: (a) forming a water phase that includes chitosan as described herein, preferably where the water phase is at a pH of 6.5 or less, more preferably at a pH of from 3 to 6, and a temperature of at least 25° C.; (b) forming an oil phase that comprises at least one benefit agent, preferably fragrance material, and at least one cross-linking agent, preferably at least one polyisocyanate, and optionally a partitioning modifier; (c) forming an emulsion, preferably an oil-in-water emulsion, by mixing the water phase and the oil phase under high shear agitation, optionally adjusting the pH of the emulsion to be in a range of from pH 2 to pH 6, preferably from pH 3 to pH 6; (d) curing the emulsion by heating, preferably to at least 40° C., for a time sufficient to form a shell at the interface of the oil droplets with the water phase, where the shell will comprise a polymeric material that is the reaction product of the chitosan and the cross-linking agent, and where the shell surrounds a core that comprises the benefit agent.

The capsules may be made according to a process that comprises the following steps: (a) forming a water phase by treating the chitosan with a mixture of a first acid and a second acid, the first acid comprising a strong acid, and the second acid comprising a weak acid, wherein the chitosan is treated at a pH of 6.5 or less, or even less than pH 6.5, or even at a pH of from 3 to 6, and a temperature of at least 25° C. for at least one hour; (b) forming an oil phase comprising dissolving together at least one benefit agent and at least one polyisocyanate, optionally with an added oil (e.g., partitioning modifier) and/or solvent; (c) forming an emulsion by mixing under high shear agitation the water phase and the oil phase into an excess of the water phase, thereby forming droplets of the oil phase that include the benefit agent dispersed in the water phase, and optionally adjusting the pH of the emulsion to be in a range from pH 2 to pH 6, preferably pH 3 to pH 6; (d) curing the emulsion by heating to at least 40° C., for a time sufficient to form a shell at an interface of the droplets with the water phase, the shell comprising the reaction product of the polyisocyanate and the acid treated chitosan, and the shell surrounding the core comprising the droplets of the oil phase and benefit agent.

Chitosan may be added into water in a jacketed reactor and at pH from 2 or even from 3 to 6.5, adjusted using acid such as concentrated HCl. The chitosan of this mixture may be acid-treated by heating to elevated temperature, such as 85° C. in 60 minutes, and then may be held at this temperature from 1 minute to 1440 minutes or longer. The water phase then may be cooled to 25° C. Optionally, depolymerization and/or deacetylation of the chitosan may also be further facilitated or enhanced by enzymes. An oil phase may be prepared by dissolving an isocyanate such as trimers of xylylene Diisocyanate (XDI) or polymers of methylene diphenyl isocyanate (MDI), in oil at 25° C. Diluents, for example isopropyl myristate, may be used to adjust the hydrophobicity of the oil phase. The oil phase may then be added into the water phase and milled at high speed to obtain a targeted size. The emulsion may then be cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion may be heated to 85° C. in 60 minutes and then held at 85° C. for 360 minutes to cure the particles. The slurry may then be cooled to room temperature.

Optionally, the aqueous phase may include an emulsifier. Non-limiting examples of emulsifiers include anionic surfactants (such as alkyl sulfates, alkyl ether sulfates, and/or alkyl benzenesulfonates), nonionic surfactants (such as alkoxylated alcohols, preferably comprising ethoxy groups), polyvinyl alcohol, and/or polyvinyl pyrrolidone. It may be that solubilized chitosan can provide emulsifying benefits in the present applications. Emulsifier, if employed, is typically from about 0.1 to 40% by weight, preferably 0.2 to about 15% by weight, more typically 0.5 to 10% by weight, based on total weight of the aqueous phase.

The capsules of the present disclosure include a core. The core comprises a benefit agent. The core of a particle is surrounded by the shell. When the shell is ruptured, the benefit agent in the core is released. Additionally or alternatively, the benefit agent in the core may diffuse out of the particle, and/or it may be squeezed out. Suitable benefit agents located in the core may include benefit agents that provide benefits to a surface, such as a fabric or hair.

Bio-Based Capsules with High Heat Resistance-HR Bio-Based Capsules

The bio-based capsules described in this section are suitable for use in the processes described herein, i.e. continuous and late addition batch processing. Additionally, as the inventors have found that these bio-based capsules are more resistant to elevated temperatures than their other bio-based capsule counterparts, the bio-based capsules described in this section may also be used in a traditional batch process.

As noted, some bio-based capsules, for example, the capsules described heretofore, while providing excellent delivery of their benefit agents, can be susceptible to heat degradation. However, as disclosed hereafter, the inventors have also discovered bio-based capsules which have a much higher degree of resistance to heat and do not degrade to the extent as the foregoing when subjected to heat for extended periods of time. As such, these capsules may be utilized in the processes described herein or in the batch processing of particles without the need to limit the exposure time of these bio-based capsules to elevated temperatures.

These capsules much like the foregoing include a core surrounded by a shell, and much like the foregoing, the core may comprise a benefit agent. The shell can include or be a polymeric material comprising the reaction product of a cross-linking agent from an oil phase, and a chitosan derived from a water phase. The shell may comprise a polymeric material that is the reaction product of chitosan, and a cross-linking agent, wherein the cross-linking agent comprises an isocyanate component, the isocyanate component comprising a mixture of two or more di- and/or poly-isocyanates, the di- and/or poly-isocyanates each comprising an aromatic moiety; and, wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.

Surprisingly, it has been found that leakage can be controlled as a function of two isocyanates, each comprising at least one aromatic moiety, which when combined with chitosan yield low leakage capsules in different matrices and carriers, to an extent heretofore unachieved with degradable constructs. More particularly the cross-linking agent comprises an isocyanate component, wherein the isocyanate component comprises a mixture of two or more di- and/or poly-isocyanates, derived from an oil phase, the di- and/or poly-isocyanates each comprising an aromatic moiety; and each isocyanate is independently selected from the group of an alpha-aromatic isocyanate and a beta-aromatic isocyanate. The mixture of di- and/or poly-isocyanates can comprise at least one alpha isocyanate and at least one beta isocyanate.

The capsules of this type comprise a shell and a core, wherein the shell surrounds said core and said core comprises one or more benefit agents. Said shell may comprise from about 90% to about 100%, optionally from about 95% to about 100%, optionally from about 99% to about 100% by weight of the shell of a polymeric material that is the reaction product of chitosan derived from an aqueous phase and a cross-linking agent.

Enhanced performance in terms of lower leakage and retention of core material in carrier material is surprisingly obtainable wherein the weighted % NCO of the aromatic isocyanate of the isocyanate component is from 15 to 32% or even from 20 to 26%, or even from 20 to 25% by weight, or even from 21 to 25% by weight. The isocyanate component has a ratio of alpha-aromatic isocyanate to beta-aromatic isocyanate in the range from 20 to 50% by weight, optionally from 25 to 40% by weight, optionally from 30 to 35% by weight.

The shell may comprise a polymeric material that is the reaction product of a cross-linking agent of at least two isocyanate monomers, oligomers, or prepolymers, and the chitosan, The method of making the capsules comprises the steps of: (i) forming a water phase dissolving or dispersing chitosan in water. Optionally, prior to capsule shell formation, the chitosan can be pretreated with one or more of a redox initiator such as a persulfate or with an acid or acids at a pH of from pH 3 to pH 6.5, or even a pH of from 4 to 6.5 at a temperature of at least 25° C., for at least one hour or to achieve a viscosity of less than 1500 centipoise (cp) and optionally less than 500 cp, to form a treated chitosan; and, (ii) forming an oil phase comprising dissolving together at least one benefit agent and an isocyanate component comprising at least two isocyanates having an aromatic moiety wherein the weighted % NCO of the aromatic isocyanate of the isocyanate component is from 15 to 32% or even from 20 to 26%, or even from 20 to 25% by weight, or even from 21 to 25% by weight; and, (iii) forming an emulsion by mixing under high shear agitation the water phase and the oil phase into an excess of the water phase, thereby forming droplets of the oil phase dispersed in the water phase, and optionally adjusting the pH of the emulsion to be in a range from pH 3 to pH 6; and, (iv) curing the emulsion by heating to at least 40° C., for a time sufficient to form a shell at an interface of the droplets with the water phase, the shell comprising the reaction product of the cross-linking component and the chitosan, and the shell surrounding the core comprising the droplets of the oil phase. Optionally the chitosan can be a treated chitosan. The droplets of the oil phase comprise the benefit agent in that the benefit agent is itself an oil or soluble in an added oil or soluble in the cross-linking agent.

In certain embodiments at least 21 wt % of the shell comprises chitosan. In embodiments, the isocyanate component comprises methylenediphenyl isocyanate and xylylene diisocyanate in a weight ratio of from 1:2 to 1:1.75. In embodiments, the isocyanate component comprises by weight 30 to 40% methylenediphenyl isocyanate and from 60 to 70% xylylene diisocyanate.

The shell may comprise a polymeric material that is the reaction product of chitosan derived from an aqueous phase, and a cross-linking agent comprising an isocyanate component comprising a mixture of two or more di- and/or poly-isocyanates, derived from an oil phase, the di- and/or poly-isocyanates each comprising an aromatic moiety. The isocyanates are di-isocyanates, tri-isocyanates or a mixture of di- and tri-isocyanates.

The alpha-aromatic isocyanate is selected from the group consisting of:

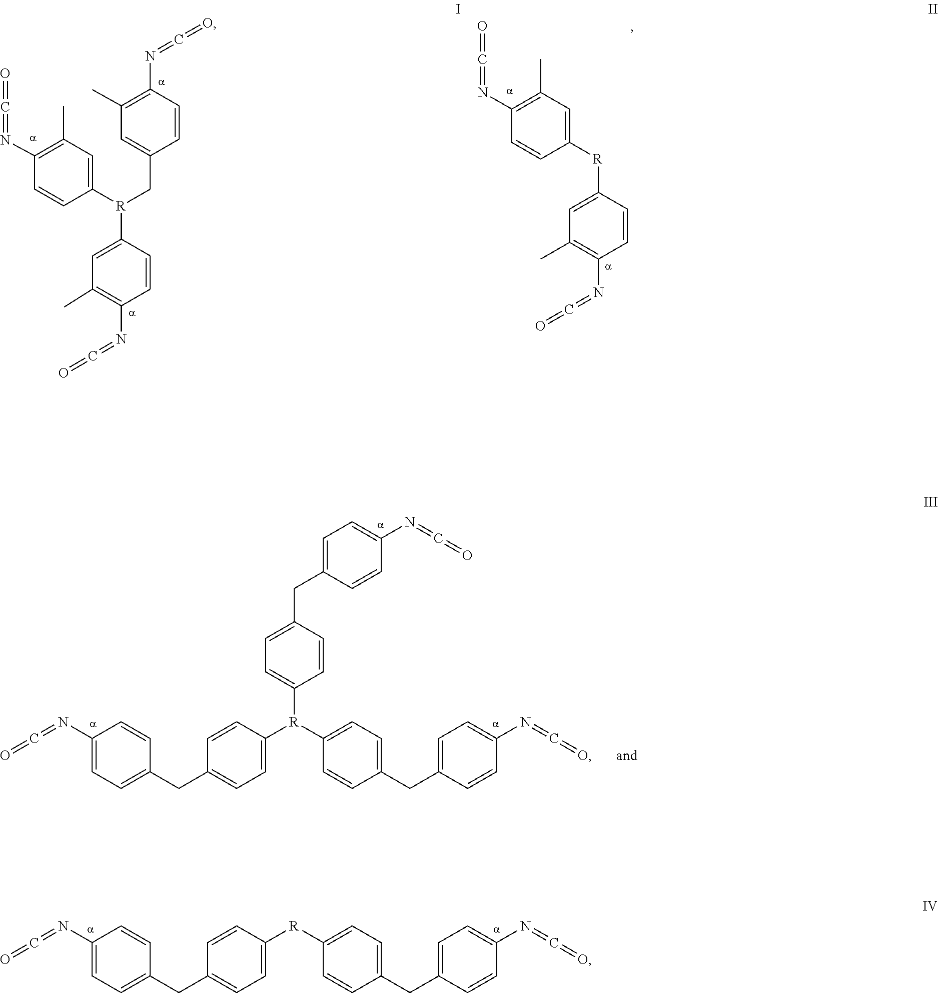

wherein R is a biuret, a uretdione, an isocyanurate, a polyol having a pendant urethane group, a polyamine having a urea pendant group, a polyacid with an anhydride group, a poly-isocyanate comprising a biuret, a poly-isocyanate comprising a uretdione, or a polyisocyanate comprising an isocyanurate.

R in structures I, II, III and IV and XII and XIII for example comprises moieties with at least two or more functional groups that link into the respective di- or tri-isocyanate. R in structures I, II, III and IV and XII and XIII for example can comprise polyol, or a polyol having one or more pendant urethane groups, or a polyamine, such as a polyamine having one or more urea pendant groups or other linking groups, a polyacid with an anhydrate group, a poly-isocyanate comprising a biuret, a poly-isocyanate comprising a uretdione, or a polyisocyanate comprising an isocyanurate. In structures I, II, III and IV and XII and XIII for example the R moieties include at least two or more functional groups that link into the respective di- or tri-isocyanate.

The aromatic isocyanates of formulas I-XVI are based on derivative variations of generally commercially available isocyanates such as xylylene diisocyanate (XDI), toluene diisocyanate (TDI) and methylene diphenyl diisocyanates (MDI).

The above selected aromatic isocyanates are generally available commercially. For example, Covestro in Leverkusen, Germany is a supplier of polyisocyanates and prepolymers under the Desmodur brand. Polyisocyanates conforming to the structures I-XVI disclosed herein are available under the Desmodur E brand of isocyanates and prepolymers, and/or can also be derived synthetically. Optionally aromatic isocyanates are also commercially available from sources such as Mitsui Chemicals, Inc., Tokyo, Japan such as the Takenate brand of isocyanates, e.g., Takenate D-110N adducts based on xylylene diisocyanate.

Specific examples of alpha-aromatic isocyanates that may be useful can be selected from the group of:

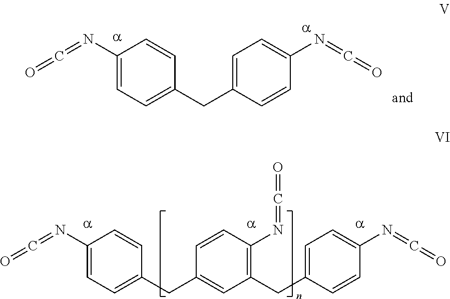

wherein n is an integer from 1 to 24, optionally from 1 to 18, or even from 1 to 12, or even from 1 to 8,

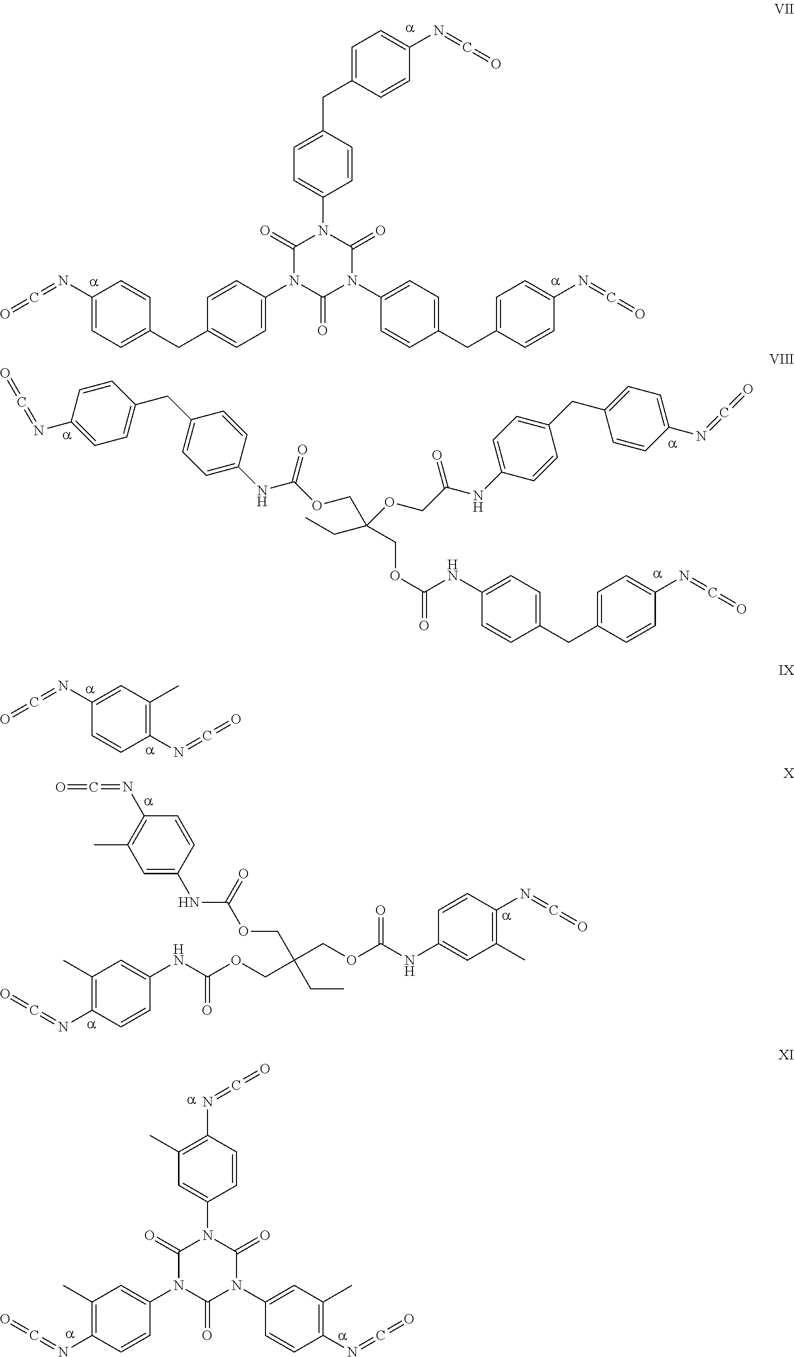

The beta-aromatic isocyanate that can be useful can be selected from the group consisting of:

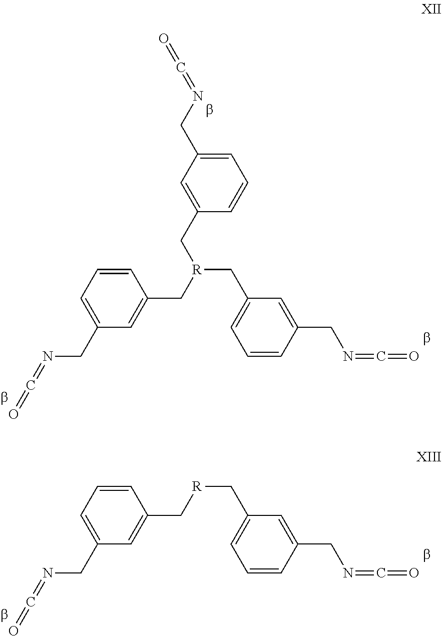

wherein R is a polyol having a pendant urethane group, a polyamine having a urea pendant group, a polyacid with an anhydrate group, a poly-isocyanate comprising a biuret, a poly-isocyanate comprising a uretdione, a polyisocyanate comprising an isocyanurate.

The alpha-aromatic isocyanate can also be selected from the group of toluene diisocyanate, methylene diphenyl diisocyanate, polymeric methylene diphenyl diisocyanate, naphthalene diisocyanate, phenylene diisocyanate, isomers thereof, adducts thereof, and combinations thereof, and optionally selected from methylene diphenyl diisocyanate, polymeric methylene diphenyl diisocyanate, isomers thereof, adducts thereof, and combinations thereof. Specific examples of beta-aromatic isocyanates that can be useful can be selected from the group of:

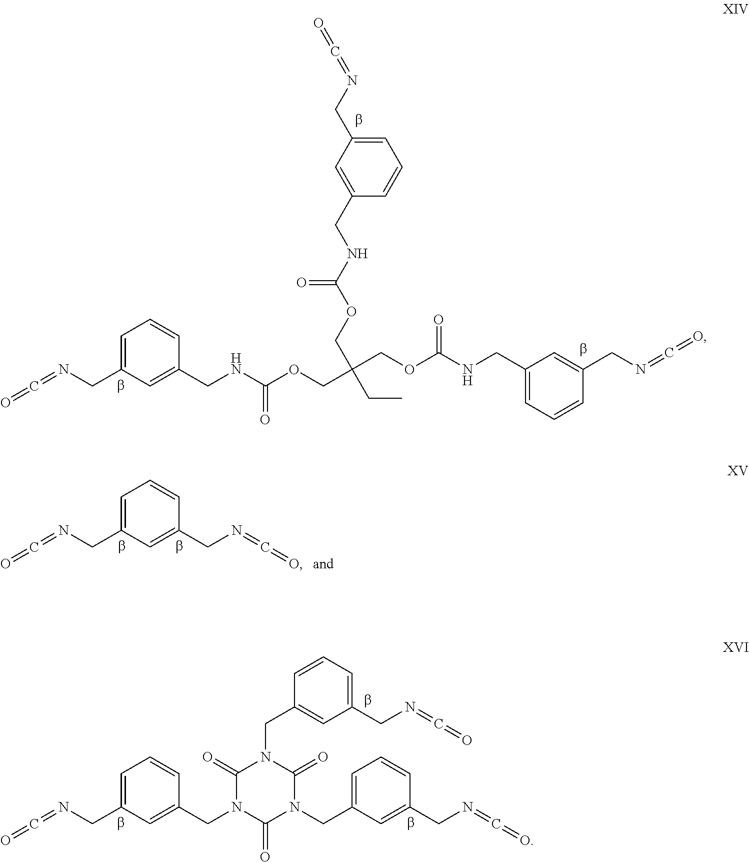 [SMILES: CCC(COC(=O)NCc1cccc(CN=C=O)c1)(COC(=O)NCc1cccc(CN=C=O)c1)COC(=O)NCc1cccc(CN=C=O)c1 ; O=C=NCc1cccc(CN=C=O)c1 ; O=C=NCc1cccc(Cn2c(=O)n(Cc3cccc(CN=C=O)c3)c(=O)n(Cc3cccc(CN=C=O)c3)c2=O)c1]

The beta-aromatic isocyanate can also be selected from the group of xylylene diisocyanate, trimethylolpropane adducts of xylylene diisocyanate, tetramethylxylidene diisocyanate, isomers thereof, adducts thereof, and combinations thereof.

### Benefit Agent

The benefit agent is selected to provide a benefit under preferred uses of the treatment composition. The benefit agent in the core (and/or provided in the carrier) may be selected from the group consisting of fragrance materials, perfume oils, fragrance oils, silicone oils, waxes, hydrocarbons, fatty acids, essential oils, lubricants, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, bonding agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, synthetic or natural actives, antibacterial actives, antiperspirant actives, cationic polymers, dyes, and mixtures thereof.

Referring back to the capsules, the core may comprise from about 5% to about 100%, by weight of the core, of a benefit agent. The core may comprise from about 45% to about 95%, preferably from about 50% to about 80%, more preferably from about 50% to about 70%, by weight of the core, of the benefit agent.

The benefit agent may comprise an aldehyde-comprising benefit agent, a ketone-comprising benefit agent, or a combination thereof. Such benefit agents, such as aldehyde- or ketone-containing perfume raw materials, are known to provide preferred benefits, such as freshness benefits. The benefit agent may comprise at least about 20%, preferably at least about 25%, more preferably at least about 40%, even more preferably at least about 50%, by weight of the benefit agent, of aldehyde-containing benefit agents, ketone-containing benefit agents, or combinations thereof.

The benefit agent may be a hydrophobic benefit agent. Such agents are compatible with the oil phases that are common in making the delivery particles of the present disclosure.

The benefit agent in the core preferably comprises fragrance material (or simply “fragrance”), which may include one or more perfume raw materials. Fragrance is particularly suitable for encapsulation in the presently described delivery particles, as the fragrance-containing particles can provide freshness benefits across multiple touchpoints.

Where the benefit agent comprises a fragrance, the particles can comprise about 0.1% to about 20%, alternatively about 0.1% to about 10%, alternatively about 1% to about 15%, alternatively 2% to about 10%, alternatively combinations thereof and any whole percentages within any of the aforementioned ranges, of encapsulated perfume by weight of the particles.

The fragrance may comprise one or more, optionally two or more, perfume raw materials (or “PRM”). Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partition coefficient (P), which may be described in terms of logP, determined according to the test method described in Test methods section. Based on these characteristics, the PRMs may be categorized as Quadrant I, Quadrant II, Quadrant III, or Quadrant IV PRMs, as described in more detail below. A perfume having a variety of PRMs from different quadrants may be desirable, for example, to provide fragrance benefits at different touchpoints during normal usage.

PRMs having a boiling point B.P. lower than about 250° C. and a logP lower than about 3 are known as Quadrant I PRMs. Quadrant 1 PRMs are optionally limited to less than 30% of the perfume composition. PRMs having a B.P. of greater than about 250° C. and a logP of greater than about 3 are known as Quadrant IV PRMs, PRMs having a B.P. of greater than about 250° C. and a logP lower than about 3 are known as Quadrant II PRMs, PRMs having a B.P. lower than about 250° C. and a logP greater than about 3 are known as a Quadrant III PRMs. Suitable Quadrant I, II, III and IV PRMs are disclosed in U.S. Pat. No. 6,869,923 B1.

The fragrance may comprise a mixture of at least 3, or even at least 5, or at least 7 PRMs. The fragrance may comprise at least 10 or at least 15 PRMs. A mixture of PRMs may provide more complex and desirable aroma, and/or better perfume performance or longevity, for example at a variety of touchpoints. However, it may be desirable to limit the number of PRMs in the fragrance to reduce or limit formulation complexity and/or cost.

The fragrance may comprise at least one perfume raw material that is naturally derived. Such components may be desirable for sustainability/environmental reasons. Naturally derived PRMs may include natural extracts or essences, which may contain a mixture of PRMs. Such natural extracts or essences may include orange oil, lemon oil, rose extract, lavender, musk, patchouli, balsamic essence, sandalwood oil, pine oil, cedar, and the like. The PRMs may be selected from the group of almond oil, ambrette, angelica seeds oil, armoise oil, basil oil grand vert, benzoin resinoid, bergamot essential oil, bergamot oil, black pepper oil, black pepper essence, black currant essence, blood orange oil, bois des landes, brandy pure jungle essence, cade, chamomille romaine he, cardamom guat extract, cardamom oil, carrot heart, caryophyllene extra, cedar, cedarleaf, cedarwood oil, cinnamon bark ceylon, cinnamon ceylan extract, beeswax, citronella, citronellal, clary sage essential oil, clove leaf oil rectified, copaiba balsam, coriander, cos cos anethol, cos cos essence coriandre russie, cucumber extract, cumin oil, cypriol heart, elemi coeur, elemi oil, english white camomile, eucalyptol, Eucalyptus citriodora, eugenol, galbanum heart, ginger, grapefruit replacer, guaiacwood oil, gurjum oil, healingwood blo, helichrysum, iso eugenol, jasmine sambac, juniper berry oil, key lime, labdanum resinoid, lavandin abrialis oil, lavandin grosso, lavender essential oil, lemon cedrat, lemon oil, lemon peel verdelli, lemongrass, lemongrass oil, Litsea cubeba, magnolia flower oil, mandarin oil yellow, menthol cristalisé, mint piperita cascade, narcisse, neroli oil, nutmeg, orange flower water, orange oil, orange phase oil, organic rose water, osmanthus, patchouli, patchouli heart, patchouli oil, pepper black oil, peppermint, peru balsam absolute, petitgrain t′less, pimento berry oil, pink pepper, raspberry essence, rhodinol, rose, rose centifolia, sandalwood, sichuan pepper extract, styrax white, sweet orange oil, tangerine oil, vanilla, vetiver, violet leaves, violette feuilles, wormwood oil, and combinations thereof.

Other suitable examples of benefit agents which may be provide in the core of the capsules of the present disclosure include hueing dyes, enzymes, anionic surfactant, silicone wheat protein, silicones, anionic silicones, cationic polysaccharides, vinyl additional polymers, polyhydroxystearic acid, or combinations thereof.

The core of the encapsulates of the present disclosure may comprise a core modifier, such as a partitioning modifier and/or a density modifier. The core may comprise, in addition to the perfume, from greater than 0% to 80%, optionally from greater than 0% to 50%, optionally from greater than 0% to 30% based on total core weight, of a core modifier.

The partitioning modifier may comprise a material selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof. The partitioning modifier may preferably comprise or even consist of isopropyl myristate. The modified vegetable oil may be esterified and/or brominated. The modified vegetable oil may preferably comprise castor oil and/or soy bean oil. US Patent Application Publication 20110268802, incorporated herein by reference, describes other partitioning modifiers that may be useful in the capsules disclosed herein.

### Free Perfume

As noted, the particles can further comprise neat perfume, i.e. unencapsulated. The particles may comprise about 0.1% to about 20%, alternatively about 1% to about 15%, alternatively 2% to about 10%, alternatively combinations thereof and any whole percentages within any of the aforementioned ranges, of unencapsulated perfume by weight of the particles. Perfumes are generally described in U.S. Pat. No. 7,186,680. Free perfume can be fragrance oil/perfume oil.

The particles can comprise encapsulated perfume. Encapsulated perfume can be provided as a plurality of perfume microcapsules. A perfume microcapsule can be perfume oil enclosed within a shell.

The relationship between free perfume and encapsulated perfume can require some balance. In an effort to create anti-habituating fragrances for the user, it may be beneficial to configure the free perfume with less than 50% overlap/similarity to that of the encapsulated perfume. Anti-habituating fragrances and PRM's are described in additional detail in U.S. Pat. No. 11,844,854. The less than 50% overlap can be created via the use of different PRM's in the free perfume versus the encapsulated wherein less than 50% of the PRM's in the free perfume are the same as those of the encapsulated perfume. The less than 50% overlap can be created via the use of different weight percentages of PRM's over that of the free perfume. For example, at least 50% of the PRM's of the encapsulated perfume can have a weight percentage difference over the same PRM's in the free perfume. Alternatively, combinations of weight percentages and different PRM's can be utilized to formulate anti-habituating fragrances.

### Water-Soluble Carrier

The particle of the present invention may comprise 25% to 99% by weight of a water-soluble carrier. While any suitable material may be utilized as the water-soluble carrier, one preferred composition comprises polyalkylene glycol.

Polyalkylene glycol water-soluble carrier can be materials selected from polyethylene glycol, polypropylene glycol, ethylene oxide/propylene oxide block copolymers, and combinations thereof. For example, the water-soluble carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

The particles can comprise about 25% to about 99% by weight of the particles of PEG. Optionally, the particles can comprise from about 35% to about 99%, optionally from about 40% to about 99%, optionally from about 50% to about 99%, optionally combinations thereof and any whole percentages or ranges of whole percentages within any of the aforementioned ranges, of PEG by weight of the respective particles. Preferably, the PEG present in the particles is characterized by a weight average molecular weight (Mw) ranging from about 2,000 to about 20,000 Daltons, optionally from about 2000 to about 15000 Da, alternatively from about 4000 to about 20000 Da, alternatively from about 4000 to about 15000 Da, alternatively from about 4000 to about 12000 Da, alternatively from about 5000 to about 11000 Da, alternatively from about 6000 to about 10000 Da, alternatively from about 7000 to about 9000 Da, alternatively combinations thereof. Suitable PEGs include homopolymers commercially available from BASF under the tradenames of Pluriol® E 8000.

While combinations of molecular weight PEG may be utilized, it is believed that PEG have a molecular weight below 4000 Da, should have a relatively low level of weight percentage use as compared to the PEG having a molecular weight above that of 4000 Da. It is believed that PEG having a molecular weight below 4000 Da, has a lower melt temperature and can introduce processing difficulties. To offset this lower melt temperature of the lower molecular weight PEG, higher molecular weight PEG may be utilized at a higher weight percentage than that of the lower molecular weight PEG. For example, the higher molecular weight PEG may be introduced at a ratio of at least about 1.1:1. It is worth noting that the lower the molecular weight of a first PEG constituent, the higher the molecular weight of the second PEG constituent may be needed in order to alleviate the processing difficulties. Or, in such configurations, a higher ratio of weight percentage of the second PEG constituent may be needed, e.g., at least about 1.3:1.

Alternatively, the polyalkylene glycol water-soluble carrier can be an ethylene oxide-propylene oxide-ethylene oxide (EOx₁POyEOx₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer improve cleaning.

Suitable ethylene oxide-propylene oxide-ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

The polyalkylene glycol water-soluble carrier also included “end capped” polyalkylene glycol. Typically, polyalkylene glycol has two —OH groups at both ends of the polymer chain, “end capped” means at least one or both of the —OH groups are reacted and connected to end capping organic group different from the polyalkylene glycol. Preferably, the end capping organic group R connected to the —OH groups of the polyalkylene glycol via an ether bond (—O—R) and/or ester bond (—O—(C═O)—R), where R is a linear or branched C₁-C₃₀ alkyl group, a cycloalkyl group with 5 to 9 carbon atoms, a C₆-C₃₀ arylalkyl group, a C₆-C₃₀ alkylaryl group. More preferably, R is a linear or branched C₁-C₃₀ alkyl group, even more preferably a linear C₁-C₆ alkyl group and even more preferably a methyl (CH₃).

Examples of suitable “end capped” polyalkylene glycol include a polyethylene glycol fatty alcohol ether of formula:

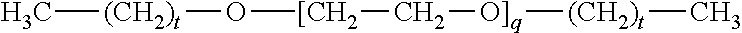

wherein
q is based on a molar average, a number from 30 to 250.
t is based on a molar average, a number from 0 to 30.

Examples of suitable “end capped” polyalkylene glycol include a polyethylene glycol fatty alcohol esters of formula:

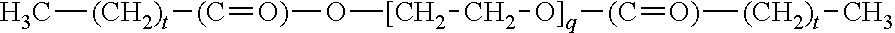

wherein
q is based on a molar average, a number from 30 to 250.
t is based on a molar average, a number from 0 to 30.

Additional options for polyalkylene glycol include modified polyalkylene glycol having a formula of:

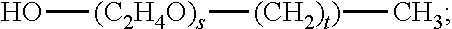

wherein
s is based on a molar average, a number from 63-68
t is based on a molar average, a number from 13 to 19, preferably 17.

Carrier compositions comprising the above formulation may comprise from about 10 wt. % to about 60 wt. % of the above modified polyalkylene glycol, preferably from about 20 wt. % to about 50 wt. %, even more preferably from about 25 wt. % to about 45 wt. %, and most preferably from about 30 wt. % to about 40 wt. %.

### Other Water-Soluble Carriers

The water-soluble carrier can be a material that is soluble in a wash liquor within a short period of time, for instance less than about 10 minutes.

The particle may further comprise other water-soluble carriers selected from inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

Suitable inorganic alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium silicate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium silicate, and combinations thereof.

Suitable inorganic alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium silicate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium silicate, and combinations thereof.

Organic salts, such as organic alkali metal salts and organic alkaline earth metal salts, contain carbon.

Suitable organic alkali metal salts can be selected from the group consisting of sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate, and combinations thereof.

Suitable organic alkali metal salts can be selected from the group consisting of calcium acetate, calcium citrate, calcium lactate, calcium tartrate, calcium ascorbate, calcium sorbate, magnesium acetate, magnesium citrate, magnesium lactate, magnesium tartrate, magnesium ascorbate, magnesium sorbate, and combinations thereof.

Carbohydrates may be selected from the group consisting of monosaccharides, disaccharides, oligosaccharides, polysaccharides and derivatives thereof, and combinations thereof.

Suitable monosaccharides may be selected from the group consisting of erythrose, ribose, arabinose, xylose, glucose, isoglucose, dextrose, galactose, mannose, erythrulose, ribulose, fructose, sorbose, rhamnose, fucose, deoxyribose, ribose, and combinations thereof.

Suitable disaccharides sugar may be selected from the group consisting of sucrose, maltose, lactose, isomaltose, trehalose, cellobiose, melibiose, gentiobiose, and combinations thereof.

Suitable oligosaccharides may be selected from the group consisting of maltotriose, raffinose, stachyose, and combinations thereof.

Preferably the sugar is selected from the group consisting of fructose, glucose, isoglucose, galactose, raffinose, and combinations thereof. More preferably the sugar comprises or is sucrose.

Suitable polysaccharides may be selected from the group consisting of homopolysaccharides, heteropolysaccharides, and combinations thereof.

Suitable polysaccharides may be selected from the group consisting of starch, corn starch, wheat starch, rice starch, potato starch, tapioca starch, modified starch, cellulose, carboxymethyl cellulose, methyl cellulose, ethyl cellulose, propyl cellulose, hydroxyethyl cellulose, hydroxypropyl cellulose, cellulose esters, cellulose amides, glycogen, pectin, dextrin, maltodextrin, corn syrup solids, alginates, xyloglucans, xylan, glucuronoxylan, arabinoxylan, mannan, dextran, glucomannan, galactoglucan, xanthan, carrageenan, locust bean gum, Arabic gum, tragacanth, and combinations thereof.

Carbohydrate derivatives may be selected from the group consisting of aminosugars, deoxysugars, sugar alcohols, sugar acids, and combinations thereof.

Suitable sugar alcohol may be selected from the group consisting of sorbitol, mannitol, isomalt, maltitol, lactitol, xylitol, erythritol, and combinations thereof. Preferably the sugar alcohol is selected from the group consisting of mannitol, sorbitol, xylitol and combinations thereof. Sugar alcohol polyols are described in additional detail in U.S. Pat. No. 11,920,111.

The water-soluble carrier may be selected from the group consisting of clay, zeolites, silica, silicates, citric acid and salts thereof, fatty alcohol, glyceryl diester of hydrogenated tallow, and combinations thereof.

The water-soluble carrier may be a water-soluble polymer selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, and combinations thereof.

Some specific examples of suitable carrier materials can include combinations of the foregoing. For example, a carrier material may comprise a mixture of a first wt. % of polyethylene glycol; a second wt. % of sodium bicarbonate; a third wt. % of sodium acetate trihydrate. In such configurations, the first wt. % may be from about 30 to about 70, more preferably from about 40 to about 60, even more preferably from about 45 to about 58, or most preferably from about 52 to about 56.

The second wt. % may be from about 10 to about 30, more preferably from about 15 to about 25, even more preferably from about 15 to about 20. It is worth noting that where higher percentages of sodium bicarbonate are utilized, dissolution problems can occur. For example, where hard water is utilized as part of the wash process, it is believed that a portion of the sodium carbonate may react with the hard water and form calcium carbonate. As the calcium carbonate may not dissolve entirely in the wash process, pieces of calcium carbonate may appear on clothes which can give consumers a negative impression of the performance of the particle.

The third wt. % may be from about 10 to about 30, more preferably from about 15 to about 25, even more preferably from about 15 to about 20. It is worth noting that where higher percentages of sodium acetate are utilized, discoloring as well as generation of odor can occur. It is believed that the sodium acetate can degrade and form acetic acid. The acetic acid can cause discoloration of the particles as well as a vinegary smell for the particles. This can cause consumers to have a very negative impression of the performance of the particles, particularly where the particles are advertised to provide a great smelling fragrance to articles of laundry.

As another example, the carrier material may comprise polyethylene glycol, block copolymer of ethylene oxide and propylene oxide and clay, e.g. bentonite and/or other organic clay materials.

As another example, the carrier material may comprise sodium chloride, propylene glycol, and sodium starch octenylsuccinate.

As another example, the carrier material may comprise sodium acetate, dipropylene glycol, cellulose, sodium hydroxide, and sodium acrylate copolymer.

As yet another example, the carrier material may comprise a modified polyethylene glycol as described herein along with polyethylene glycol. The modified polyethylene glycol may have a higher molecular weight than the polyethylene glycol. Additionally, the modified polyethylene glycol may be present at a higher weight percentage than the polyethylene glycol.

As yet another example, the carrier material may comprise from about 45% to about 80%, preferably about 50% to about 70%, preferably about 50% to about 60%, by weight sugar alcohol polyol selected from the group consisting of or selected from or selected from at least one of erythritol, xylitol, mannitol, isomalt, maltitol, lactitol, trehalose, lactose, tagatose, sucralose, and mixtures thereof.

### Particles

The particles can each have a mass from about 1 mg to about 1 gram, alternatively from about 2 mg to about 500 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg or a mixture of the foregoing. The plurality of particles within a package can comprise less than 10% by weight of particles having an individual mass less than about 10 mg. This can reduce the potential for dust.

An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller particles are thought to provide better packing of the particles in a container and faster dissolution in the wash. It may be desirable to vary the volume of the particles within a package to create variable dissolution profiles. For example, a first plurality of particles may comprise a volume in the range of from about 0.003 cm³ to about 0.15 cm³, and a second plurality of particles may have a volume which is greater than that of the first plurality of particles. In such configurations, it may be beneficial for the first plurality of particles to comprise capsules containing a first benefit agent and/or a first optional constituent while the second plurality of particles comprises a second benefit agent and/or a second optional constituent. The first benefit agent may be different than the second benefit agent. Additionally, the first optional constituent may be different than the second optional constituent. Additionally, in order to distinguish the first plurality of particles from the second plurality of particles, the first plurality of particles may have a first dye, e.g., a first color, while the second plurality of particles comprises a second dye, e.g. a second color, wherein the first color and the second color are different. The first plurality of particles and the second plurality of particles may be provided in the same container. The ratio of the first plurality of particles to the second plurality of particles within the same container, can be about 2.5:1, where the first plurality provides primarily a scent benefit to a consumer and the second plurality provides a fabric conditioning benefit, e.g. fabric softening, to the consumer.

The particles of the present disclosure may have any shape selected from the group consisting of spherical, hemispherical, compressed hemispherical, cylindrical, disc, circular, lentil-shaped, oblong, cubical, rectangular, star-shaped, flower-shaped, discorectangle and any combinations thereof. Lentil-shaped refers to the shape of a lentil bean. Preferably, the particles of the present disclosure have a hemispherical or compressed hemispherical shape. Compressed hemispherical refers to a shape corresponding to a hemisphere that is at least partially flattened such that the curvature of the curved surface is less, on average, than the curvature of a hemisphere having the same radius.

The particles of the present disclosure may each have a maximum dimension of from about 2 mm to 10 mm, preferably from about 3 mm to about 9 mm, more preferably from about 4 mm to about 8 mm. the particle may have a substantially flat base and a height measured orthogonal to said base and together said particles have a distribution of heights, wherein said distribution of heights has a mean height between about 1 mm and about 5 mm and a height standard deviation less than about 0.3. The particles disclosed herein can have ratio of maximum dimension to minimum dimension from about 10 to 1, optionally from about 8 to 1, optionally about 5 to 1, optionally about 3 to 1, optionally about 2 to 1. The particles disclosed herein can be shaped such that the particles are not flakes. Particles having a ratio of maximum dimension to minimum dimension greater than about 10 or that are flakes can tend to be fragile such the particles are prone to becoming dusty. The fragility of the particles tends to decrease with decreasing values of the ratio of maximum dimension to minimum dimension.

It is worth noting that preferably each of the particles comprises at least one flat surface. The flat surface of each of the particles can correspond to an interface between the particle (during formation) and the belt upon which the particles are formed. Preferably the flat surface has a maximum dimension that is no less than 33 percent of the height of the particle, even more preferably no less than 40 percent of the height, or most preferably no less than 50 percent of the height of the particle, or most preferably no less than 70 percent of the height of the particle. A larger flat base for each of the particles can facilitate processing as the particles are less likely to roll off of the belt during process. Additionally, a larger flat base can eliminate the need to provide vacuum to the belt to ensure that the particles do not roll off of the belt during processing. A plurality of perfume-containing particles of the present invention can have different shapes, sizes, mass, colors, capsules, benefit agents and/or density.

The particles can comprise about 25% to 99% by weight water-soluble carrier and capsules dispersed in the water-soluble carrier. The particles can be provided with from about 0.1% to about 20% by weight of the composition capsules.

The particles can comprise less than about 20% by weight anionic surfactant, optionally less than about 10% by weight anionic surfactant, optionally less than about 5% by weight anionic surfactant, optionally less than about 3% by weight anionic surfactant, optionally less than about 1% by weight anionic surfactant. The particles can comprise from 0 to about 20%, optionally from 0 to about 10%, optionally from about 0 to about 5%, optionally from about 0 to about 3%, optionally from about 0 to about 1% by weight anionic surfactant. In some configurations, the particles of the present disclosure may be substantially free of anionic surfactant.

The particles can comprise less than about 10% by weight water.

### Optional Constituents

The particles of the present disclosure may further comprise fabric softening actives, cationic polymers, malodor control agents, dye transfer inhibitors, anticaking agents, and mixtures thereof, described in U.S. Pat. No. 11,920,111, entitled Fabric Care Composition.

Yet another optional constituent which may be comprised by the particles, in addition to any of the foregoing optional constituents or independently thereof, includes a deposition aid. The particles can comprise about 0.5% to about 10% by weight a deposition aid selected from the group of: (1) a poly alpha-1,3-glucan ether compound having a weight average molecular weight of from 90000 Da to 350000 Da, and a degree of cationic substitution of from 0.03 to 1.0 optionally from 0.05 to 0.09, optionally 0.15 to 0.8, optionally 0.07 to 0.11; (2) a poly alpha-1,6-glucan ether compound comprising a poly alpha-1,6-glucan substituted with at least one positively charged organic group, wherein the poly alpha-1,6-glucan comprises a backbone of glucose monomer units wherein at least 65% of the glucose monomer units are linked via alpha-1,6-glycosidic linkages, wherein the poly alpha-1,6-glucan ether compound has a degree of substitution of about 0.001 to about 3.0, and wherein the poly alpha-1,6-glucan ether compound is characterized by: a) a weight average molecular weight of from about 80000 Da to about 500000 Da, and/or b) having been derived from a poly alpha-1,6-glucan having a weight average molecular weight of from about 50000 Da to about 450000 Da, determined prior to substitution with the least one positively charged organic group; (3) a poly alpha-1,3-glucan alpha-1,6-glucan ether compound having a weight average molecular weight of from 90000 Da to 350000 Da, and a degree of cationic substitution of from 0.03-1.0 optionally from 0.05-0.09, optionally 0.15 to 0.8 optionally 0.07 to 0.11; and (4) combinations thereof.

Suitable poly alpha-1,3-glucan ether compounds that can be used in the plurality of particles described herein are described in United States Patent Publication 2023/0043452 A1. The poly alpha-1,3-glucan ether compound can have a weight average molecular weight of from 90000 Da to 350000 Da and a degree of cationic substitution of from 0.03 to 0.8. The plurality of particles can comprise about 0.5% to about 10% by weight a poly alpha-1,3-glucan ether compound having a weight average molecular weight of from 90000 Da to 350000 Da and a degree of cationic substitution of from 0.03 to 0.8.

Optionally the poly alpha-1,3-glucan ether compound can have a weight average molecular weight of from 90000 to 300000 Da. Optionally, the poly alpha-1,3-glucan ether compound can have a weight average molecular weight of from 100000 Da to 175000 Da. Optionally, the poly alpha-1,3-glucan ether compound can have a degree of cationic substitution of from 0.03 to 0.8. The poly alpha-1,3-glucan ether compound can comprise a backbone that is substantially linear, having fewer than 10% branch points as a percent of glycosidic linkages in the backbone.

The poly alpha-1,3-glucan ether compound can comprise from 425 to 1200 structural units having the following structure:

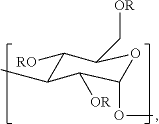

wherein each R is independently an H or a positively charged organic group.

The poly alpha-1,3-glucan ether compound is substituted with a positively charged organic group that comprises a substituted ammonium group. Optionally, the substituted ammonium group can be a trimethylammonium group.

The poly alpha-1,3-glucan ether compound can be substituted with at least one positively charged organic group that comprises an alkyl group or hydroxy alkyl group. Optionally, the at least one positively charged organic group can comprise a quaternary ammonium hydroxypropyl group.

Optionally, the poly alpha-1,3-glucan ether compound can be provided as a premix, wherein the premix comprises from 5% to 20%, by weight of the premix, of the poly alpha-1,3-glucan ether compound. Optionally, the premix can further comprise water.

Suitable poly alpha-1,6-glucan ether compounds that can be used in the plurality of particles described herein are described in United States Patent Publication 2021/0395649 A1 and United States Patent Application Publication No. 2021/0395649. The plurality of particles can comprise about 0.5% to about 10% by weight a poly alpha-1,6-glucan ether compound comprising a poly alpha-1,6-glucan substituted with at least one positively charged organic group. The poly alpha-1,6-glucan can comprise a backbone of glucose monomer units wherein at least 65% of the glucose monomer units are linked via alpha-1,6-glycosidic linkages. The poly alpha-1,6-glucan ether compound can be characterized by: a) a weight average molecular weight of from about 80000 Da to about 500000 Da, and/or b) having been derived from a poly alpha-1,6-glucan having a weight average molecular weight of from about 50000 Da to about 450000 Da, determined prior to substitution with the least one positively charged organic group. The poly alpha-1,6-glucan ether compound can be further characterized by a degree of substitution of about 0.001 to about 3.0. Optionally, the poly alpha-1,6-glucan ether compound can be characterized by a weight average molecular weight of from about 80000 Da to about 300000 Da. Optionally, the poly alpha-1,6-glucan ether compound can be characterized by having been derived from a poly alpha-1,6-glucan having a weight average molecular weight of from about 50000 Da to about 350000 Da, determined prior to substitution with the least one positively charged organic group. Optionally, the poly alpha-1,6-glucan can comprise a backbone of glucose monomer units wherein at least 70% of the glucose monomer units are linked via alpha-1,6-glycosidic linkages. Optionally, the poly alpha-1,6-glucan ether compound can be characterized by a weight average molecular weight of from about 150000 Da to about 225000 Da, a degree of substitution of from about 0.05 to about 0.5, and wherein from about 5% to about 20% of the backbone glucose monomer units have branches via alpha-1,2 and/or alpha-1,3-glycosidic linkages.

Optionally, at least 3% of the backbone glucose monomer units can have branches via alpha-1,2 and/or alpha-1,3-glycosidic linkages. Further optionally, the positively charged organic group can comprise a substituted ammonium group. If present, the quaternary ammonium group can comprise at least one C₁ to C₁₈ alkyl group. Optionally, the quaternary ammonium group can comprise a trimethylammonium group.

The poly alpha-1,6-glucan ether compound comprising a poly alpha-1,6-glucan can be substituted with at least one positively, charged organic group, the positively charged organic group comprising a quaternary ammonium hydroxyalkyl group. Optionally, the quaternary ammonium hydroxyalkyl group can comprise a trimethylammonium hydroxyalkyl group.

Yet another optional constituent which may be comprised by the particles, in addition to any of the foregoing optional constituents or independently thereof, includes a softening agent.

The particles can comprise about 0.5% to about 10% by weight a softening agent comprising a branched polyester selected from the group of:
(a) a branched polyester having Formula 1

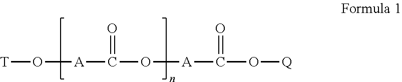

wherein:
each A is independently a branched hydrocarbon chain comprising 4 to 100 carbon atoms, preferably from 4 to 40 carbon atoms, more preferably from 12 to 20 carbon atoms, even more preferably 17 carbon atoms;
Q is selected from an alkyl chain comprising 1 to 30 carbon atoms and a hydrogen atom, preferably a hydrogen atom;
T is a hydrogen atom or a —C(O)—R wherein each R is an alkyl chain comprising 1 to 30 carbon atoms, preferably from 7 to 21 carbon atoms, even more preferably from 11 to 17 carbon atoms; and
n is an integer from 1 to about 100, more preferably from 4 to 40, even more preferably n is an integer from 5 to 20;
(b) a branched polyester having Formula 2

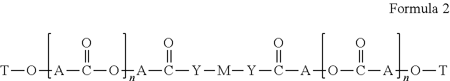

wherein:
each n is independently an integer from 1 to about 100, preferably from 4 to 40, even more preferably n is an integer from 5 to 20;
each A is independently a branched hydrocarbon chain comprising 4 to 100 carbon atoms, preferably from 4 to 40 carbon atoms, more preferably from 12 to 20 carbon atoms, even more preferably 17 carbon atoms;
each T is independently a hydrogen atom or a —C(O)—R wherein each R is an alkyl chain comprising 1 to 30 carbon atoms;
each Y is independently a linking group selected from the group of oxygen and NR2, wherein each R2 is independently selected from the group of hydrogen, or a C1-C8 alkyl; and
M is a polyalkylene glycol group;
(c) a branched polyester having Formula 3

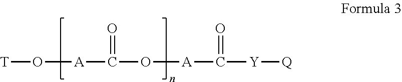

wherein:
the index n is an integer from 1 to about 100, optionally the index n is an integer from 4 to about 40, optionally the index n is an integer from 5 to about 20;
T is a hydrogen or —C(O)—R1 where in R1 is an alkyl chain comprising from 7 to 21 carbon atoms, optionally R1 is an alkyl chain comprising from 11 to 17 carbon atoms, preferably from 7 to 21 carbon atoms, even more preferably from 11 to 17 carbon atoms;
each A is independently a branched hydrocarbon chain comprising from 4 to 40 carbon atoms, optionally from 12 to 20 carbon atoms, optionally 17 carbon atoms;
Y is selected from the group of oxygen and NR2, wherein each R2 is independently selected from the group of hydrogen, or a C1-C8 alkyl, optionally, Y is selected from —O— and

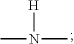

Q is selected from the group of:

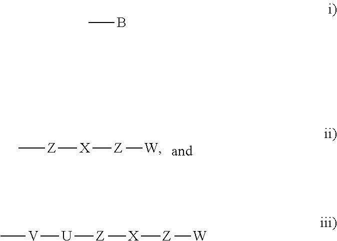

optionally, Q is selected from the group of:
i) —B, and

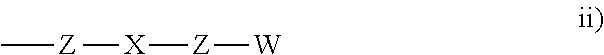

wherein
B is a substituted C1-C24 alkyl group, optionally the substituents are selected from the group of hydroxyl, primary amine, secondary amine, tertiary amine, quaternary ammonium group and mixtures thereof, more optionally B comprises from 1 to 4 substituents selected from the group of hydroxyl, primary amine, secondary amine, tertiary amine, quaternary ammonium group and mixtures thereof;
each Z is independently a substituted or unsubstituted divalent C2-C40 alkylene radical, optionally each Z is independently a substituted or unsubstituted divalent C2-C20 alkylene, most optionally each Z is independently selected from the group of:

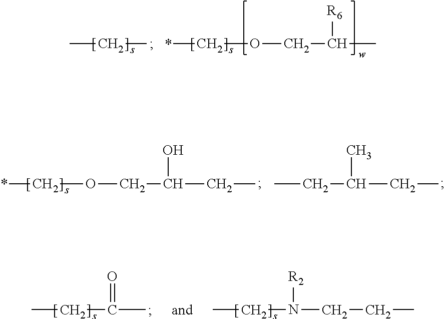

wherein * signifies a bond of the Z moiety to a X moiety of the branched polyester;
each R2 is independently selected from the group of hydrogen or a C1-C8 alkyl;
each R6 is independently selected from the group of hydrogen, or a C1-C3 alkyl, optionally a hydrogen or methyl;
each s is independently an integer from about 2 to about 8, optionally each s is independently an integer from about 2 to about 4;
each w is independently an integer from 1 to about 20, optionally each w is independently an integer from 1 to about 10, more optionally each w is independently an integer from 1 to about 8;
X is polysiloxane moiety, optionally X has the formula

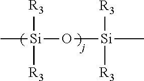

wherein each R3 is independently selected from the group of H; C1-C32 alkyl; C1-C32 substituted alkyl, C5-C32 or C6-C32 aryl, C5-C32 or C6-C32 substituted aryl; C6-C32 alkylaryl, C6-C32 substituted alkylaryl, and C1-C32 alkoxy moieties, optionally each R3 is independently selected from H; C1-C16 alkyl; C1-C16 substituted alkyl substituted with amino, hydroxyl, carboxyl or polyether moieties, optionally, each R3 is independently selected from H, methyl and methoxy groups; and
j is an integer from 5 to about 1000, optionally j is an integer from about 10 to 500, optionally j is an integer from about 20 to 300;
W is selected from the group of —OR4,

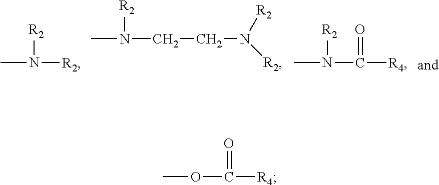

each R2 is independently selected from the group of hydrogen or a C1-C8 alkyl;
R4 is selected from a hydrogen atom, a C1-C24 alkyl group or a substituted C1-C24 alkyl group, optionally the substituents being from 1 to 4 functional moieties selected from the group of hydroxyl, primary amine, secondary amine, tertiary amine, quaternary ammonium group and mixtures thereof, C5-C32 or C6-C32 aryl, C5-C32 or C6-C32 substituted aryl; C6-C32 alkylaryl, and C6-C32 substituted alkylaryl, optionally R4 is selected from a hydrogen atom, a C1-C24 alkyl group or a substituted C1-C24 alkyl group, optionally the substituents being from 1 to 4 functional moieties selected from the group of hydroxyl, primary amine, secondary amine, tertiary amine, quaternary ammonium group and mixtures thereof;
V is a C1-C24 divalent alkylene radical or a substituted C1-C24 divalent alkylene, optionally the substituents being from 1 to 4 functional moieties selected from the group of hydroxyl, primary amine, secondary amine, tertiary amine, quaternary ammonium group and mixtures thereof;
U is —C(O)O— or —C(O)NH—; and/or
(d) a branched polyester having Formula 4

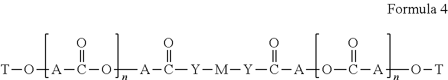

wherein:
   each index n is independently an integer from 1 to about 100;
   T is a hydrogen atom or —C(O)—R1 where in R1 is an alkyl chain comprising from 7 to 21 carbon atoms, optionally from 11 to 17 carbon atoms;
   each A is independently a branched hydrocarbon chain comprising from 4 to 40 carbon atoms, optionally from 12 to 20 carbon atoms, optionally 17 carbon atoms;
   each Y is independently selected from the group of oxygen and NR₂, wherein each R₂ is independently selected from the group of hydrogen or a C₁-C₈ alkyl;
   M is selected from the group of:
i) a C₁-C₂₄ divalent linear or branched alkylene radical, optionally the C₁-C₂₄ divalent linear or branched alkylene radical comprises one to four functional groups selected from the group of hydroxyl, primary amine, secondary amine, tertiary amine, quaternary ammonium group and mixtures thereof, optionally the C₁-C₂₄ divalent linear or branched alkylene radical has the formula:

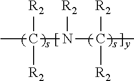

wherein each R₂ is independently selected from the group of hydrogen or a C₁-C₈alkyl; each s is independently an integer from about 2 to about 10, optionally each s is independently an integer from about 2 to about 8, optionally each s is independently an integer from about 2 to about 4; y is an integer from about 1 to about 20;
ii) —Z—X—Z—, and
iii) -(D-U-Z—X—Z-U)ₘ-D-
   wherein:
      m is an integer from 1 to about 10;
      each Z is independently a substituted or unsubstituted divalent C₂-C₄₀ alkylene radical, optionally each Z is independently a substituted or unsubstituted divalent C₂-C₂₀ alkylene, optionally each Z is independently selected from the group of:

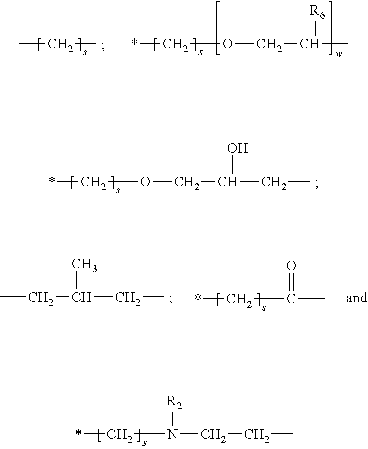

wherein * signifies a bond of the Z moiety to a X moiety of the branched polyester;
each R₂ is independently selected from the group of hydrogen or a C₁-C₈ alkyl;
each R₆ is independently selected from the group of hydrogen, or a C₁-C₃ alkyl, optionally a hydrogen or methyl;
each s is independently an integer from about 2 to about 8, optionally each s is independently an integer from about 2 to about 4;
each w is independently an integer from 1 to about 20, optionally each w is independently an integer from 1 to about 10, optionally each w is independently an integer from 1 to about 8;
X is polysiloxane moiety, optionally X has the formula:

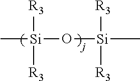

wherein each R₃ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl; C₆-C₃₂ alkylaryl, C₆-C₃₂ substituted alkylaryl, and C₁-C₃₂ alkoxy moieties, optionally each R₃ is independently selected from H; C₁-C₁₆ alkyl; C₁-C₁₆ substituted alkyl substituted with amino, hydroxyl, carboxyl or polyether moieties, optionally, each R₃ is independently selected from H, methyl and methoxy groups; and
j is an integer from 5 to about 1000, optionally j is an integer from about 20 to 500;
U is —C(O)O— or —C(O)NH—; and
each D is independently a C₁-C₂₄ divalent linear or branched alkylene radical, the alkylene radical optionally the C₁-C₂₄ divalent linear or branched alkylene radical comprises one to four functional groups selected from the group of hydroxyl, primary amine, secondary amine, tertiary amine, quaternary ammonium group and mixtures thereof; optionally the C₁-C₂₄ divalent linear or branched alkylene radical has the formula:

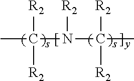

wherein each R₂ is independently selected from the group of hydrogen or a C₁-C₈ alkyl; each s is independently an integer from about 2 to about 10, optionally each s is independently an integer from about 2 to about 8, optionally each s is independently an integer from about 2 to about 4; y is an integer from about 1 to about 20;
(e) and mixtures thereof;

The branched polyester can have the structure:

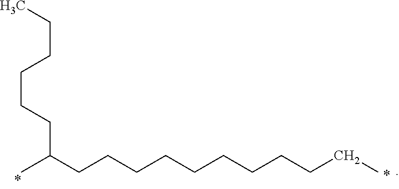 [SMILES: CCCCCCCCCCCC(C)CCCCCC]

The polyhydroxystearic acid of Formula 1 can be HYPERMER LP1, available from Croda Inc & Sederma Inc., Edison, New Jersey, United States of America. They polyhydroxystearic acid of Formula 1 can be SALACOS HS-4C, available from Nisshin Oillio Group, Ltd., Tokyo, Japan. They polyhydroxystearic acids of Formula 2 can be HYPERMER B261, HYPERMER B210, and HYPERMER B246, available from Croda Inc & Sederma Inc., Edison, New Jersey, United States of America.

The particles can comprise about 0.5% to about 10% by weight a softening agent comprising a silicone.

Useful silicones can be any silicone comprising compound. In one embodiment, the silicone is a silicone polymer selected from the group of cyclic silicones, polydimethylsiloxanes, aminosilicones, cationic silicones, silicone polyethers, silicone resins, silicone urethanes, and mixtures thereof. In one embodiment, the silicone is a polydialkylsilicone, alternatively a polydimethyl silicone (polydimethyl siloxane or “PDMS”), or a derivative thereof. In another embodiment, the silicone is chosen from an aminofunctional silicone, polyether silicone, alkyloxylated silicone, cationic silicone, ethoxylated silicone, propoxylated silicone, ethoxylated/propoxylated silicone, or combinations thereof.

In another embodiment, the silicone may be chosen from a random or blocky organosilicone polymer having the following formula:

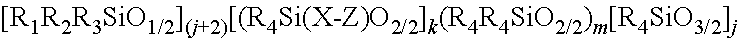

wherein:
j is an integer from 0 to about 98; in one aspect j is an integer from 0 to about 48; in one aspect, j is 0;
k is an integer from 0 to about 200, in one aspect k is an integer from 0 to about 50; when k=0, at least one of R₁, R₂ or R₃ is —X—Z;
m is an integer from 4 to about 5000; in one aspect m is an integer from about 10 to about 4000; in another aspect m is an integer from about 50 to about 2000;
R₁, R₂ and R₃ are each independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
each R₄ is independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X in the alkyl siloxane polymer comprises a substituted or unsubstituted divalent alkylene radical comprising 2-12 carbon atoms, in one aspect each divalent alkylene radical is independently selected from the group of —(CH₂)ₛ— wherein s is an integer from about 2 to about 8, from about 2 to about 4; in one aspect, each X in the alkyl siloxane polymer comprises a substituted divalent alkylene radical selected from the group of: —CH₂—CH(OH)—CH₂—; —CH₂—CH₂—CH(OH)—; and

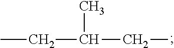

each Z is selected independently from the group of

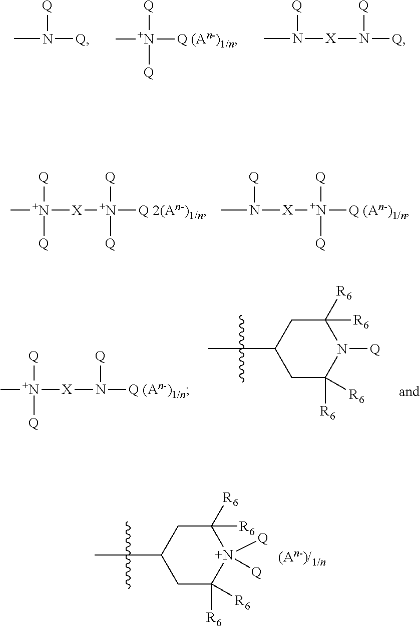

with the proviso that when Z is a quat, Q cannot be an amide, imine, or urea moiety and if Q is an amide, imine, or urea moiety, then any additional Q bonded to the same nitrogen as the amide, imine, or urea moiety must be H or a C₁-C₆ alkyl, in one aspect, the additional Q is H; for Z Aⁿ⁻ is a suitable charge balancing anion. In one aspect Aⁿ⁻ is selected from the group of Cl⁻, Br⁻, I⁻, methylsulfate, toluene sulfonate, carboxylate and phosphate; and at least one Q in the organosilicone is independently selected from —CH₂—CH(OH)—CH₂—R₅;

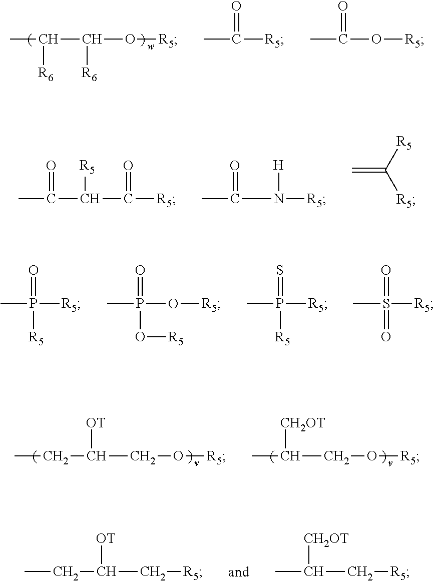

each additional Q in the organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;

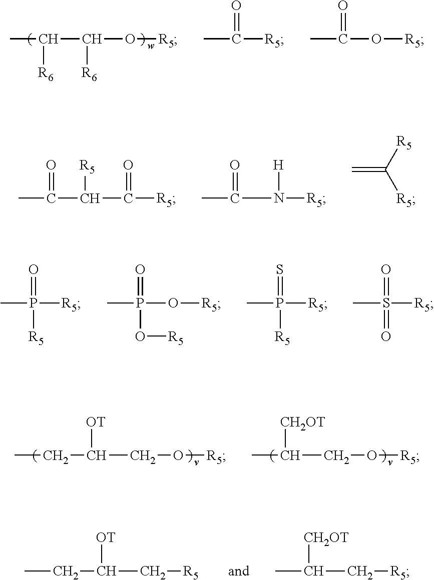

wherein each R₅ is independently selected from the group of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl;
each L is independently selected from —C(O)—R₇ or;
R₇;
w is an integer from 0 to about 500, in one aspect w is an integer from about 1 to about 200; in one aspect w is an integer from about 1 to about 50;
each R₇ is selected independently from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl; C₆-C₃₂ substituted alkylaryl and a siloxyl residue;
each T is independently selected from H, and

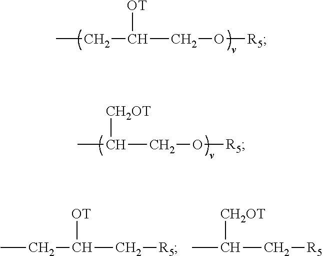

and
wherein each v in the organosilicone is an integer from 1 to about 10, in one aspect, v is an integer from 1 to about 5 and the sum of all v indices in each Q in the organosilicone is an integer from 1 to about 30 or from 1 to about 20 or even from 1 to about 10.

In another embodiment, the silicone may be chosen from a random or blocky organosilicone polymer having the following formula:

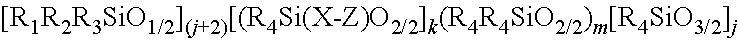

wherein
j is an integer from 0 to about 98; in one aspect j is an integer from 0 to about 48; in one aspect, j is 0;
k is an integer from 0 to about 200; when k=0, at least one of R₁, R₂ or R₃=—X—Z, in one aspect, k is an integer from 0 to about 50
m is an integer from 4 to about 5000; in one aspect m is an integer from about 10 to about 4000; in another aspect m is an integer from about 50 to about 2000;
R₁, R₂ and R₃ are each independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
each R₄ is independently selected from the group of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
each X comprises of a substituted or unsubstituted divalent alkylene radical comprising 2-12 carbon atoms; in one aspect each X is independently selected from the group of —(CH₂)ₛ—O—; —CH₂—CH(OH)—CH₂—O—;

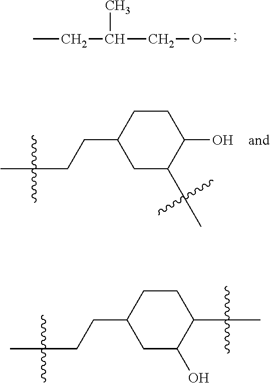

wherein each s independently is an integer from about 2 to about 8, in one aspect s is an integer from about 2 to about 4;
at least one Z in the organosiloxane is selected from the group of R₅;

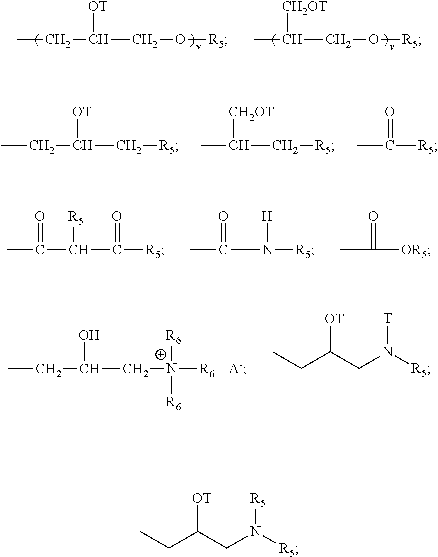

—C(R₅)₂O—R₅; —C(R₅)₂S—R₅ and

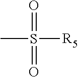

provided that when X is

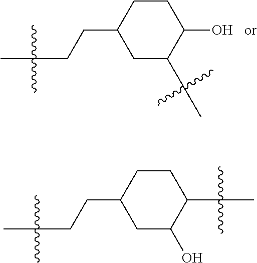 [SMILES: *CCC1CCC(O)C(*)C1 ; *CCC1CCC(*)C(O)C1]

then Z=—OR₅ or

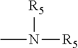

wherein A⁻ is a suitable charge balancing anion. In one aspect A is selected from the group of Cl⁻, Br⁻, I⁻, methylsulfate, toluene sulfonate, carboxylate and phosphate and each additional Z in the organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

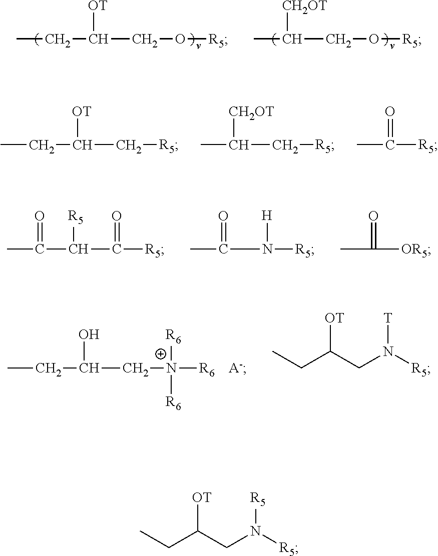

—C(R₅)₂O—R₅; —C(R₅)₂S—R₅ and

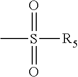

provided that when X is

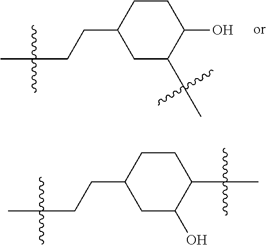 [SMILES: *CCC1CCC(O)C(*)C1 ; *CCC1CCC(*)C(O)C1]

then Z=—OR₅ or

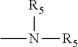

each R₅ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl,
—(CHR₆—CHR₆—O—)_{w}—CHR₆—CHR₆-L and siloxyl residue wherein each L is independently selected from —O—C(O)—R₇ or —O—R₇;

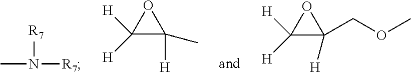

w is an integer from 0 to about 500, in one aspect w is an integer from 0 to about 200, one aspect w is an integer from 0 to about 50;
each R₆ is independently selected from H or C₁-C₁₈ alkyl;
each R₇ is independently selected from the group of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

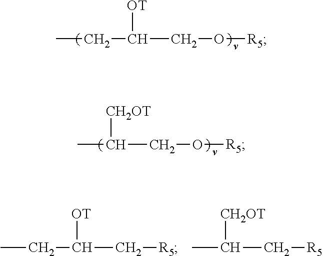

wherein each v in the organosilicone is an integer from 1 to about 10, in one aspect, v is an integer from 1 to about 5 and the sum of all v indices in each Z in the organosilicone is an integer from 1 to about 30 or from 1 to about 20 or even from 1 to about 10.

### Process for Treating Laundry

Washing machines have at least two basic sub-cycles within a cycle of operation: a wash sub-cycle and a rinse sub-cycle. The wash sub-cycle of a washing machine is the cycle on the washing machine that commences upon first filling or partially filing the wash basin with water. A main purpose of the wash sub-cycle is to remove and or loosen soil from the article of clothing and suspend that soil in the wash liquor. Typically, the wash liquor is drained at the end of the wash sub-cycle. The rinse sub-cycle of a washing machine occurs after the wash sub-cycle and has a main purpose of rinsing soil, and optionally some benefit agents provided to the wash sub-cycle from the article of clothing.

The process for treating laundry can comprise the steps of: providing an article of laundry in a washing machine; dispensing the composition comprising a plurality of particles into the washing machine, such that the plurality of particles contact one or more articles of laundry during a wash sub-cycle of the washing machine with the composition. About 5 g to about 50 g of the composition of particles can be dispensed into the washing machine.

By providing particles through the wash sub-cycle, consumers only need to dose the detergent composition and the composition comprising a plurality of particles to a single location, for example the wash basin, prior to or shortly after the start of the washing machine. This can be more convenient to consumers than using rinse added composition that is separately dispensed into the wash basin after the wash sub-cycle is completed, for example prior to, during, or in between rinse cycles. It can be inconvenient to use auto-dispensing features of modern upright and high efficiency machines since that requires dispensing the rinse added composition to a location other than where detergent composition is dispensed.

Optionally, the process can further comprise the step of contacting the article of clothing during the wash sub-cycle of the washing machine with a detergent composition comprising an anionic surfactant and/or other detergent benefit agents, e.g., perfume, bleach, brighteners, hueing dye, enzyme, combinations thereof, and the like. The detergent may comprise from about 3% to about 60%, optionally about 3% to about 40%, by weight anionic surfactant. The anionic surfactant can be selected from a sulphate, a sulphonate, a carboxylate, and mixture thereof. The detergent composition differs from the particles. The detergent composition can optionally be provided separate from the particles. The detergent composition can be dispensed separate from the composition comprising a plurality of particles.

During the wash sub-cycle, the wash basin may be filled or at least partially filled with water. The individual particles of the composition can dissolve or disperse into the water to form a wash liquor comprising the components of the particles. Optionally, if a detergent composition is employed, the wash liquor can include the components of the detergent composition and the components of the particles. The plurality of particles can be placed in the wash basin of the washing machine before the article of clothing is placed in the wash basin of the washing machine. The plurality of particles can be placed in the wash basin of the washing machine after the article of clothing is placed in the wash basin of the washing machine. The plurality of particles can be placed in the wash basin prior to filling or partially filling the wash basin with water or after filling of the wash basin with water has commenced. Or where allowed by certain washing machines, the plurality of particles can be added to the wash basin between the wash sub-cycle and the rinse sub-cycle.

If a detergent composition is employed by the consumer in practicing the process of treating an article of clothing, the detergent composition and the particles of the composition can be provided from separate packages. For instance, the detergent composition can be a liquid detergent composition provided from a bottle, sachet, water-soluble pouch, dosing cup, dosing ball, or cartridge associated with the washing machine. The particles of the composition can be provided from a separate package, by way of non-limiting example, a carton, bottle, water-soluble pouch, dosing cup, sachet, or the like. If the detergent composition is a solid form, such as a powder, water-soluble fibrous substrate, water-soluble sheet, water-soluble film, water-soluble film, water insoluble fibrous web carrying solid detergent composition, the particles of the composition can be provided with the solid form detergent composition. For instance, the particles of the composition can be provided from a container containing a mixture of the solid detergent composition and the particles of the composition. Optionally, the particles of the composition can be provided from a pouch formed of a detergent composition that is a water-soluble fibrous substrate, water-soluble sheet, water-soluble film, water-soluble film, water insoluble fibrous web carrying solid detergent composition.

### ASPECTS/COMBINATIONS/CONTEMPLATED EXAMPLES

Example A: A process for making a plurality of laundry additive particles, the process comprising the steps of: (i) mixing and heating a precursor material comprising a water-soluble carrier, wherein the precursor material is heated to a first temperature, and wherein the precursor material is at the first temperature for a first time period; (ii) mixing bio-based capsules with the precursor material such that the bio-based capsules are at or near the first temperature for a second time period, wherein the second time period is less than the first time period, and wherein the second time period is less than about 20 minutes, preferably less than about 10 minutes, more preferably less than about 7 minutes or even more preferably less than about 5 minutes, wherein the mixture of the bio-based capsules and the precursor material form a resultant mixture; and (iv) providing the resultant mixture to a distributor.
Example A1: The process of any of Example A, wherein the bio-based capsules comprise a shell surrounding a core, wherein the core comprises a benefit agent, and wherein the shell comprises a polymeric material that is a reaction product of chitosan and a cross-linking agent, and wherein the chitosan is anionically modified chitosan, cationically modified chitosan, or a combination thereof.
Example A2: The process of any of Example A1 wherein a ratio of the cross-linking agent to chitosan, based on weight, is 79:21 to 10:90, or even 2:1 to 1:8, or even 1:1 to 1:7.
Example A3: The process of any of Examples A-A2, wherein the core-shell encapsulate has a ratio of core to shell of at least 75:25, or at least 99:1, or even at least 99.5:0. 5, on the basis of weight.
Example A4: The process of any of Examples A-A3, wherein the water-soluble carrier comprises at least one of: a polyalkylene polymer of formula H—(C₂H₄O)ₓ—(CH(CH₃)CH₂O)_{y}—(C₂H₄O)_{z}—OH wherein x is from 50 to 300, y is from 20 to 100, and z is from 10 to 200; a polyethylene glycol fatty acid ester of formula (C₂H₄O)_{q}—C(O)O—(CH₂)ᵣ—CH₃ wherein q is from 20 to 200 and r is from 10 to 30; a polyethylene glycol fatty alcohol ether of formula HO—(C₂H₄O)ₛ—(CH₂)ₜ)—CH₃ wherein s is from 30 to 250 and t is from 10 to 30; a modified polyethylene glycol of formula HO—(C₂H₄O)ₛ—(CH₂)ₜ)—CH₃, wherein s is from 63-68 and t is from 13 to 19, preferably 17; C8-C22 alkyl polyalkoxylate comprising more than 40 alkoxylate units; one or more polyethylene glycols having a weight average molecular weight from 2000 to 15000; EO/PO/EO block copolymer; PO/EO/PO block copolymer; EO/PO block copolymer; PO/EO block copolymer; polypropylene glycol; ethoxylated nonionic surfactant having a degree of ethoxylation greater than 30; polyvinyl alcohol; polyalkylene glycol having a weight average molecular weight from 2000 to 15000; and mixtures thereof.
Example A5: The process of any of Examples A-A4, wherein the water-soluble carrier comprises one or more polyethylene glycols having a weight average molecular weight from about 2000 to about 15000, wherein a first polyethylene glycol has a first weight average molecular weight and a second polyethylene glycol has a second weight average molecular weight, and wherein the first weight average molecular weight is different than the second weight average molecular weight.
Example A6: The process of any of Examples A-A5, wherein the water-soluble carrier comprises: from about 45% to about 99% by weight water soluble polymer; from about 0.1% to about 20% by weight perfume; and an alkali metal salt selected from the group of alkali metal chlorides, alkali metal acetates, alkali metal citrates, and combinations thereof; wherein individual said particles have a mass from about 5 mg to about 200 mg.
Examples A7: The process of any of Examples A-A6, wherein the precursor material comprises from about 25 wt. % to about 99 wt. % of a water-soluble carrier.
Example B: A process for making a plurality of laundry additive particles, the process comprising the steps of: (i) mixing and heating a precursor material comprising a water-soluble carrier, wherein the precursor material is heated to a first temperature, and wherein the precursor material is at the first temperature; (ii) adding bio-based capsules to the precursor material; (iii) providing the precursor material and the bio-based capsules to an intermediate mixer thereby forming a resultant mixture; (iv) providing the resultant mixture to a distributor, and wherein the bio-based capsules comprise a core and a shell surrounding said core and said core comprises one or more benefit agents, wherein said shell comprises from about 90% to 100%, optionally from about 95% to 100%, optionally from about 99% to 100% by weight of the shell of a polymeric material that is the reaction product of chitosan derived from an aqueous phase and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and wherein the mixture of di- and/or poly-isocyanates comprising an aromatic moiety comprises at least one alpha-aromatic isocyanate and at least one beta-aromatic isocyanate, optionally, wherein the required isocyanates are each present in at least 20 mole percent of the total isocyanate component.
Example B1: The process of Example B, wherein the weighted % NCO of the di- and/or poly-isocyanates comprising an aromatic moiety within the isocyanate component is from 15 to 32% or even from 20 to 26%, or even from 20 to 25% by weight, or even from 21 to 25% by weight, and wherein:
   the % NCO of Isocyanate compounds is calculated as below Equation:

$$\% N C O = \frac{Number of N C O groups \cdot M W N C O group}{M W Isocyanate compound}$$

where Number of isocyanate groups (NCO groups) is the count of isocyanate groups present in the compound, MW NCO group is the molecular weight of a single NCO group, MW isocyanate compound is the molecular weight of the entire isocyanate compound, excluding any solvent or other substances that may be mixed with the isocyanate.
Example B2: The process of any of Examples B to B1, wherein the mass percent of the alpha-aromatic isocyanate in the isocyanate component is from 1 to 99% by weight, optionally from 5 to 90% by weight, optionally from 30 to 60% by weight.
Example B3: The process of any of Examples B to B2, wherein the mass percent of the beta-aromatic isocyanate in the isocyanate component is from 1% to 99% by weight, optionally from 5% to 10% by weight, optionally from 70% to 40% by weight.
Example B4: The process of any of Examples B to B3, wherein the alpha-aromatic isocyanate is selected from the group of:

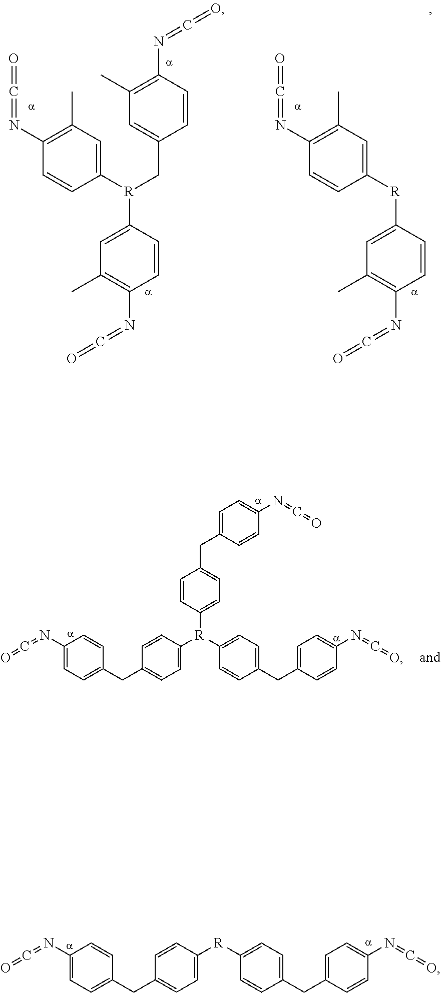

wherein R is a biuret, a uretdione, an isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
optionally, wherein the alpha-aromatic isocyanate is selected from the group of:

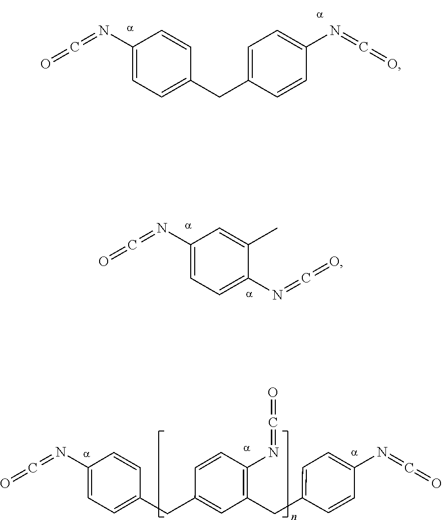

wherein n is an integer from 1 to 24,

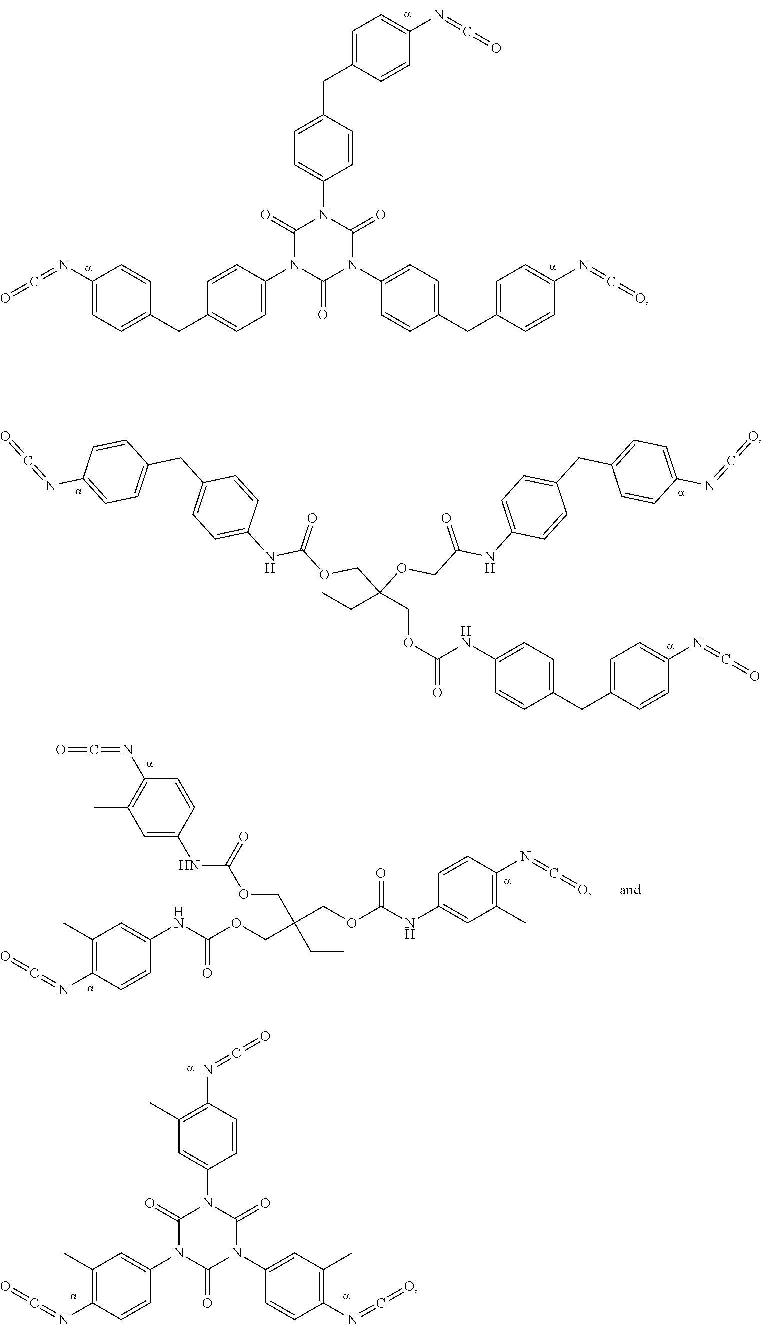 [SMILES: O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1 ; CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O]

optionally, wherein the alpha-aromatic isocyanate is selected from the group of toluene diisocyanate, methylene diphenyl diisocyanate, polymeric methylene diphenyl diisocyanate, naphthalene diisocyanate, phenylene diisocyanate, isomers thereof, adducts thereof, and combinations thereof.
Example B5: The process of any of Examples B to B4, wherein the beta-aromatic isocyanate is selected from the group of:

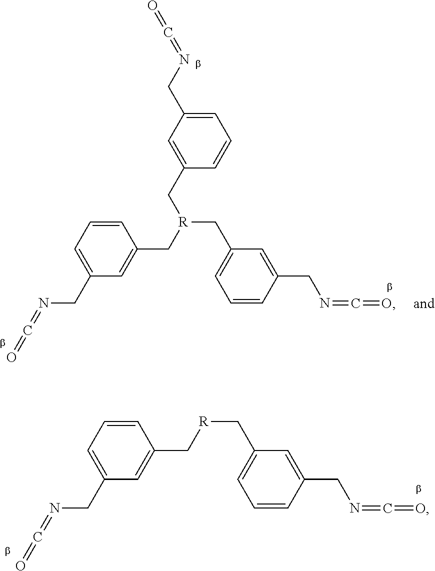

wherein R is a biuret, a uretdione, a isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate,
   optionally,
   wherein the beta-aromatic isocyanate selected from the group of:

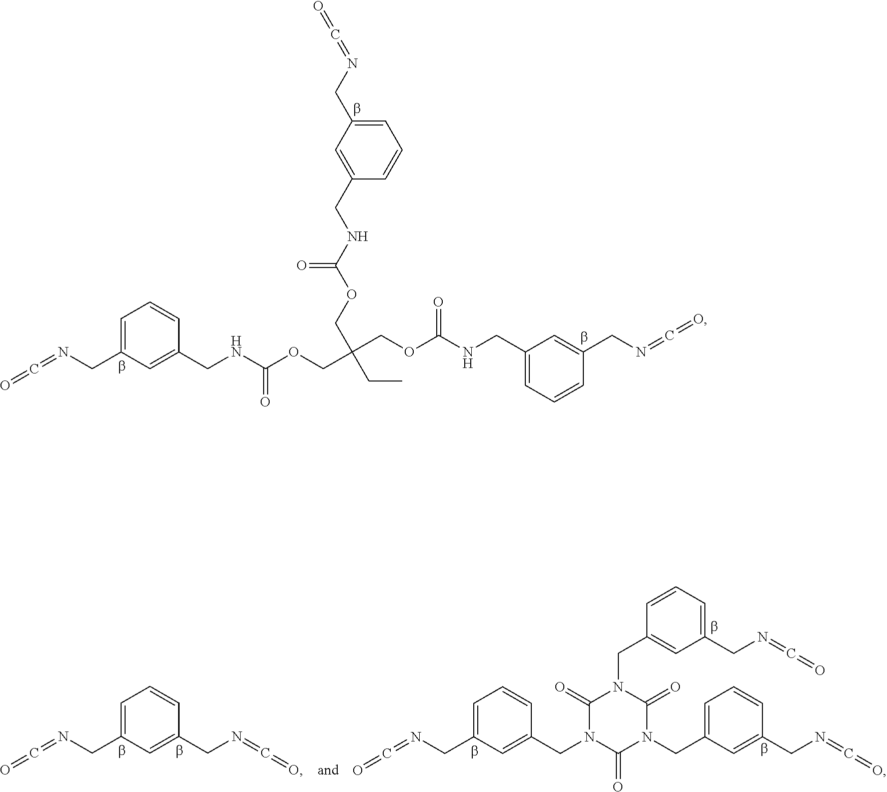

optionally, wherein the beta-aromatic isocyanate is selected from the group of xylylene diisocyanate, trimethylolpropane adducts of xylylene diisocyanate, tetramethylxylidene diisocyanate, isomers thereof, adducts thereof, and combinations thereof.
Example B6: The process of any of Examples B to B5, wherein the isocyanate component comprises at least two di- and/or poly-isocyanates selected from methylenediphenyl diisocyanate, polymeric methylenediphenyl isocyanate, and a trimethylol propane-adduct of xylylene diisocyanate, optionally, wherein the isocyanate component comprises methylenediphenyl isocyanate, polymeric methylenediphenyl isocyanate, and a trimethylol propane-adduct of xylylene diisocyanate in a weight ratio of from 1:2 to 1:1.75, optionally, wherein the isocyanate component comprises by weight 30 to 40%, optionally 34% a combination of methylenediphenyl isocyanate and polymeric methylenediphenyl isocyanate and from 60 to 70%, optionally 66% a trimethylol propane-adduct of xylylene diisocyanate.
Example B7: The process of any of Examples B to B6, wherein the chitosan is characterized by a weight average molecular weight of from about 100 kDa to about 80,000 kDa, or even from 100 kDa to about 600 kDa, optionally from about 100 kDa to about 500 kDa, optionally from about 100 kDa to about 400 kDa, optionally from about 100 kDa to about 300 kDa, optionally from about 100 kDa to about 200 kDa.
Example B8: The process of any of Examples B to B7, wherein the ratio of the cross-linking agent to chitosan, based on weight, is 79:21 to 10:90, or even 2:1 to 1:8, or even 1:1 to 1:7.
Example B9: The process of any of Examples B to B8, wherein the core-shell encapsulate has a ratio of core to shell of at least 75:25, or at least 99:1, or even at least 99.5:0. 5, on the basis of weight.
Example B10: The process of any of Examples B to B9, said precursor material comprises from about 25% to about 99% by weight water-soluble carrier, and wherein said water-soluble carrier comprises a combination of at least two of the following: polyalkylene glycol, inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, sugar, polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, or combinations thereof.
Example B11: The process of any of Examples B to B10, wherein the carrier consists of a mixture of polyalkylene glycol and at least two of: sodium bicarbonate, sodium acetate trihydrate, clay, sodium chloride, sodium starch octenylsuccinate, cellulose, sodium hydroxide, sodium acrylate copolymer, and sugar.
Example B12: The process of Example B11, wherein the polyalkylene glycol comprises polyethylene glycol or a mixture of polyethylene glycol and modified polyethylene glycol having a higher molecular weight than polyethylene glycol.
Example B13: The process of Example B12, wherein the polyethylene glycol comprises a mixture of a first polyethylene glycol having a first molecular weight and a second polyethylene glycol having a second molecular weight, wherein the first molecular weight is greater than the second molecular weight.
Example B14: The process of any of Examples B to B13, wherein the precursor material is heated to a first temperature for a first period of time and wherein the bio-based capsules are exposed to the first temperature for a second period of time which is less than the first period of time.

### Test Methods

It is understood that the test methods that are disclosed in the Test Methods section of the present application should be used to determine the respective values of the parameters of Applicant's claimed subject matter as claimed and described herein.

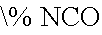

The % NCO of Isocyanate compounds is calculated as below Equation:

$$\% N C O = \frac{Number of N C O groups \cdot M W N C O group}{M W Isocyanate compound}$$

Where Number of NCO groups is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.
When isocyanate is used as a mixture of multiple isocyanates, the % NCO is reported as the weighted sum of mass percentages for each individual isocyanate within the mixture.

All temperatures herein are in degrees Celsius (° C.) unless otherwise indicated. Unless otherwise specified, all measurements herein are conducted at 20° C. and under the atmospheric pressure.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

In the following examples, the abbreviations, materials or tradenames correspond to the materials listed in Table 1. The examples are intended to be illustrative in nature and are not intended to be limiting.

TABLE 1
Materials - chitosan

| Trade Name | Company/City | Material |
|---|---|---|
| CHITOCLEAR | Primex EHF, Siglufjordur, Iceland | chitosan |

The di- and/or poly-isocyanates comprise an aromatic moiety. The isocyanates employed have two functional groups: an isocyanate group and an aromatic moiety. For ease of reference, the isocyanate molecules can be subdivided into several classifications.

A first grouping can be on the basis of the presence or absence of an aromatic moiety within the whole molecule; hence the following two classification are defined:
1—isocyanate comprising at least one aromatic moiety.
2—isocyanate not comprising any aromatic moiety.
   For convenience, the presence of the aromatic moiety can be further classified as either alpha or beta based on carbon-atom naming. Hence the isocyanate comprising an aromatic moiety can be subdivided.
1. i) isocyanate comprising an alpha-aromatic moiety; and,
1. ii) isocyanate comprising a beta-aromatic moiety.
   For ease of reference, Group 1, i) and ii) classifications are then referred to as:
1. i) alpha-aromatic
1. ii) beta-aromatic
   and Group 2 as
2. “non-aromatic”
   This naming convention is reflected in Table 2 below:

TABLE 2
Materials-isocyanate

| Trade | Company/ | | | Class- | |
|---|---|---|---|---|---|
| Name | City | Material | Chemical structure | ification | NCO |
| TAKENATE D-110N | Mitsui Chemicals America, Inc., Rye Brook, NY | polyisocyanate prepolymer; adduct of xylylene diisocyanate | 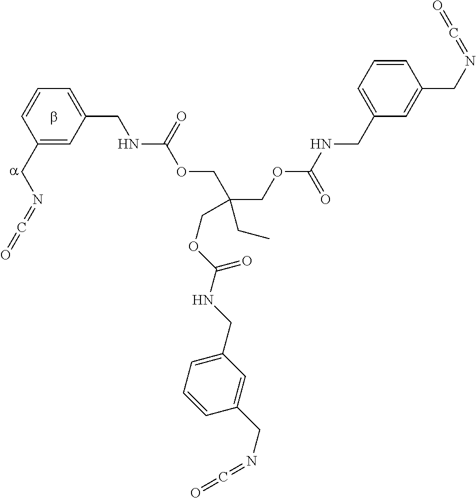 | Beta- Aromatic | 15.3% |
| MMRL MONDUR MR- LIGHT | Covestro LLC Pittsburgh, PA | polymeric diphenylmethane diisocyanate | 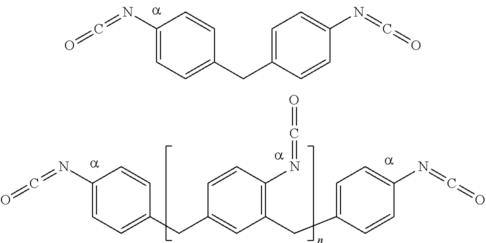 | Alpha- Aromatic | 31.3% |
| LUPRANATE M20 ISOCYANATE | BASF, Florham Park, NJ | polymethylene polyphenyl- polyisocyanate | 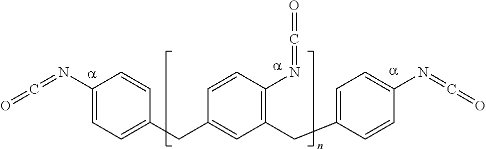 | Alpha- Aromatic | 31.5% |

It is theorized that the aromatic ring can affect reactivity. Surprisingly it was found that isocyanate comprising alpha-aromatic moieties are more reactive than isocyanate comprising beta-aromatic moieties. This is believed due to the nature of the electron-withdrawing aromatic ring, enhancing the electrophilic character of the isocyanate group (NCO). Isocyanate comprising alpha-aromatic moiety or moieties have a phenyl ring attached to the NCO group, which is theorized to enhance reactivity. The delocalization of electrons in the aromatic ring is believed to make the alpha carbon even more electron-deficient, making it a stronger electrophile, hence more prone to nucleophilic interaction with amines such with the chitosan amine group. Isocyanate comprising a beta-aromatic moiety or moieties, on the other hand, have less of the influence of an electron-withdrawing aromatic ring and are attached to the beta carbon. While they are still reactive, they are generally less reactive than their alpha-aromatic isocyanate counterparts. This can lead to faster reaction rates, making the alpha-aromatic isocyanates, such as of Group 1 i), more efficient in certain applications. However, their high reactivity can also make them more challenging to handle and may require additional precautions such as the potential unwanted reactivity with PRMs. Surprising, unexpected improvements were found when the isocyanate component is selected to comprises a mixture of two or more isocyanates each comprising an aromatic moiety; and each isocyanate is independently selected from the group of an alpha-aromatic isocyanate and a beta-aromatic isocyanate. It is to be understood that the isocyanate can be di- or polyisocyanate.

### EXAMPLES

The examples provided below are intended to be illustrative in nature and are not intended to be limiting.

### Perfume Loss of a Variety of Capsules

The perfume loss measured below was based upon polyethylene glycol-based particles and sodium acetate based particles where indicated. Each of the particles was made by hand and subjected to heating conditions to simulate one of conventional batch processing, modified batch processing, or continuous processing, each of which is disclosed herein.
4 hours—the particles (including capsules) were stored at an elevated temperature noted below in Tables 3-5.
8 hours—particles (including capsules) are stored at an elevated temperature as noted in Tables 3-5 below.
16 hours—particles (including capsules) are stored at an elevated temperature as noted in Tables 3-5 below.

For late addition batch processing, as described herein, recall that the capsules are added to the precursor material near the distributor. The particles (including capsules) for this example, were stored at an elevated temperature for the period of time noted in Tables 3-5 below.

Similarly, for the continuous process, the capsules were added to the precursor material upstream of the distributor. The particles (including capsules) for this example were stored at an elevated temperature for the period of time noted in Tables 3-5, below.

The formulation of the particles is provided in Table 6.

TABLE 3
Perfume Loss for PEG-based particles

| Process | Batch | Batch | Batch |
|---|---|---|---|
| Process Conditions/ | Aged 4 hours | Aged 16 hours | Aged 18 hours |
| Capsule type | at 60° C. | at 60° C. | at 80° C. |
| Melamine | 7.2 | 3.5 | 3.8 |
| Formaldehyde | | | |
| Polyacrylate | 16.5 | 30.6 | 52.9 |
| Bio based capsules - | 121 | 120 | 92.7 |
| non HR. | | | |

TABLE 4
Perfume Loss for PEG-based particles

| Process | Late addition batch | Continuous |
|---|---|---|
| Process Conditions/ | Direct cooling <1 | Aged 4 minutes at |
| Capsule type | min at elevated temp | 60 degrees C. |
| Melamine | 1.4 | 3.9 |
| Formaldehyde | | |
| Polyacrylate | 8 | 15 |
| Bio based capsules - | 14.8 | 23.5 |
| non HR. | | |

Perfume loss was measured for sodium acetate-based particles made in accordance with the process described herein. Made in accordance with the formulation show in Table 6 below.

TABLE 5
Perfume Loss for sodium acetate-based particles

| Process | Batch | Batch | Continuous |
|---|---|---|---|
| Process | Aged 3 hours | Aged 16 hours | Aged 4 minutes |
| Conditions | at 70° C. | at 70° C. | at 60 degrees C. |
| Bio based | 79.4 | 100 (Reference) | 45.6 |
| capsules - | | | |
| non HR. | | | |

TABLE 6
Compositions of PEG-based and sodium acetate-based particles

| | Sodium Acetate | |
|---|---|---|
| | Particles | PEG based particles |
| | Component Material | Component Material |
| | (Wt %) | (Wt %) |
| PEG8000 | 0 | 90. |
| Encapsulate Slurry (32% | 4.4 | 4.4 |
| perfume activity) | | |
| Sodium Acetate Trihydrate | 85 | 0 |
| Aerosil 200 | 1.5 | 0 |
| Water | 9 | 0 |
| Minors (dye, . . . ) | balance | balance |

For the data above in Tables 3 through 5, the lower the value in the table, the lower the loss of benefit agent in from the capsule core. As shown by the data, the bio-based capsules described herein (excluding the HR bio-based capsules) had significant benefit agent, e.g., perfume loss from their core when exposed to high temperatures, e.g., 60 degrees C., for an extended period of time, e.g., 3 hours or more. Based on the data obtained, this is the case regardless of the carrier, i.e. PEG or PEG/sodium acetate.

Additionally, for sodium acetate particles, the bio-based capsules appeared to be even more sensitive to heat as they exhibited quite a large loss of benefit agent from their core only after 4 minutes. In contrast, the PEG based particle exhibited almost 50% less loss than its sodium acetate particle counterpart.

Based on the foregoing data, the process for making particles which retain the most efficacy for their capsules, involves a few steps: (i) mixing and heating a precursor material comprising a water-soluble carrier, wherein the precursor material is heated to a first temperature, and wherein the precursor material is at the first temperature for a first time period; (ii) mixing bio-based capsules with the precursor material such that the bio-based capsules are at or near the first temperature for a second time period, wherein the second time period is less than the first time period, and wherein the second time period is less than about 20 minutes, preferably less than about 10 minutes, more preferably less than about 7 minutes or even more preferably less than about 5 minutes, wherein the mixture of the bio-based capsules and the precursor material form a resultant mixture; and (iii) forming a plurality of discrete particles from the resultant mixture. The first time period can be greater than 2 hours. However, the second time period can be from greater than zero to about 20 minutes, preferably from about 0.5 minutes to about 20 minutes, preferably from about 0.5 minutes to about 10 minutes, even more preferably from about 0.5 minutes to about 7 minutes, or most preferably from about 0.5 minutes to about 5 minutes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a plurality of laundry additive particles, the process comprising the steps of:
(i) mixing and heating a precursor material comprising a water-soluble carrier, wherein the precursor material is heated to a first temperature, and wherein the precursor material is at the first temperature for a first time period;
(ii) mixing bio-based capsules with the precursor material such that the bio-based capsules are at or near the first temperature for a second time period, wherein the second time period is less than the first time period, and wherein the second time period is greater than zero and less than about 20 minutes, wherein the mixture of the bio-based capsules and the precursor material form a resultant mixture; and
(iii) forming a plurality of discrete particles from the resultant mixture.

2. The process of claim 1, wherein the second time period is less than about 10 minutes.

3. The process of claim 1, wherein the second time period is less than about less than about 7 minutes.

4. The process of claim 1, wherein the second time period is less than about 5 minutes.

5. The process of claim 1, wherein the first time period is greater than 2 hours.

6. The process of claim 1, wherein the second time period is at least 0.5 minutes.

7. The process of claim 1, wherein the bio-based capsules comprise a shell surrounding a core, wherein the core comprises a benefit agent, and wherein the shell comprises a polymeric material that is a reaction product of chitosan and a cross-linking agent.

8. The process of claim 7, wherein the chitosan is characterized by a weight average molecular weight of from about 100 kDa to about 500 kDa.

9. The process of claim 7, wherein the chitosan is characterized by a weight average molecular weight of from about 100 kDa to about 400 kDa.

10. The process of claim 7, wherein the chitosan is characterized by a weight average molecular weight of from about 100 kDa to about 200 kDa.

11. The process of claim 7, wherein the chitosan is characterized by at least one of the following:
(a) a Polydispersity Index (Mw/Mn) of from about 1.2 to about 4, preferably from about 1.4 to about 3.8, more preferably from about 2.2 to about 2.6; and/or
(b) a value defined by (Mz−Mp) of from about 60 to about 3500 kDa; and/or
(c) a degree of deacetylation of at least about 50% to about 99%.

12. The process of claim 7, wherein the cross-linking agent comprises a polyisocyanate, preferably a polyisocyanate selected from the group consisting of: a polyisocyanurate of toluene diisocyanate; a trimethylol propane adduct of toluene diisocyanate; a trimethylol propane adduct of xylylene diisocyanate; 2,2′-methylenediphenyl diisocyanate; 4,4′-methylenediphenyl diisocyanate; 2,4′-methylenediphenyl diisocyanate; [diisocyanato(phenyl)methyl]benzene; toluene diisocyanate; tetramethylxylidene diisocyanate; naphthalene-1,5-diisocyanate; 1,4-phenylene diisocyanate; 1,3-diisocyanatobenzene; derivatives thereof; and combinations thereof.

13. The process of claim 7, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and wherein the mixture of di- and/or poly-isocyanates comprising an aromatic moiety comprises at least one alpha-aromatic isocyanate and at least one beta-aromatic isocyanate.

14. The process of claim 13, wherein the weighted % NCO of the di- and/or poly-isocyanates comprising an aromatic moiety within the isocyanate component is from 15 to 32% or even from 20 to 26%, or even from 20 to 25% by weight, or even from 21 to 25% by weight, and wherein:
the % NCO of Isocyanate compounds is calculated as below Equation:
$$\% N C O = \frac{Number of N C O groups \cdot M W N C O group}{M W Isocyanate compound}$$
where Number of isocyanate groups (NCO groups) is the count of isocyanate groups present in the compound, MW NCO group is the molecular weight of a single NCO group, MW isocyanate compound is the molecular weight of the entire isocyanate compound, excluding any solvent or other substances that may be mixed with the isocyanate.

15. The process of claim 14, wherein the weighted % NCO of the di- and/or poly-isocyanates comprising an aromatic moiety within the isocyanate component is from 15 to 32% or even from 20 to 26%, or even from 20 to 25% by weight, or even from 21 to 25% by weight, and wherein.

16. The process of claim 1, wherein the bio-based capsules comprise a shell surrounding a core, wherein the core comprises a benefit agent, and said shell comprises from about 90% to 100% by weight of the shell of a polymeric material that is the reaction product of chitosan derived from an aqueous phase and a cross-linking agent.

17. The process of claim 1, wherein said precursor material comprises from about 25% to about 99% by weight water-soluble carrier, and wherein said water-soluble carrier comprises a combination of at least two of the following: polyalkylene glycol, inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, sugar, polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, or combinations thereof.

18. The process of claim 17, wherein the carrier comprises of a mixture of polyalkylene glycol and at least two of: sodium bicarbonate, sodium acetate trihydrate, clay, sodium chloride, sodium starch octenylsuccinate, cellulose, sodium hydroxide, sodium acrylate copolymer, and sugar.

19. The process of claim 18, wherein the polyalkylene glycol comprises polyethylene glycol or a mixture of polyethylene glycol and modified polyethylene glycol having a higher molecular weight than 1000.

20. The process of claim 19, wherein the polyethylene glycol comprises a mixture of a first polyethylene glycol having a first molecular weight and a second polyethylene glycol having a second molecular weight, wherein the first molecular weight is greater than the second molecular weight.
